(19) United States
(12) Patent Application Publication
(10) Pub. No.: US 2024/0324787 A1
(43) Pub. Date: Oct. 3, 2024

(54) SUPPORT SURFACE COVERS, AND ASSOCIATED MATERIALS, DEVICES, SYSTEMS, AND METHODS

(71) Applicant: Sizewise Rentals, L.L.C., Kent, WA (US)

(72) Inventors: David Delroy Driscoll, Milwaukee, WI (US); Craig Salvatore Miller, Corona, WA (US)

(21) Appl. No.: 18/623,617

(22) Filed: Apr. 1, 2024

Related U.S. Application Data
(60) Provisional application No. 63/493,284, filed on Mar. 30, 2023.

(51) Int. Cl. A47C 27/00; A47C 31/00; B32B 3/04; B32B 3/08; B32B 5/02; B32B 7/04; B32B 7/12; B32B 27/12; B32B 27/40

(52) U.S. Cl. CPC A47C 27/008; A47C 27/006; A47C 31/001; B32B 3/04; B32B 3/08; B32B 5/024; B32B 7/04; B32B 7/12; B32B 27/12; B32B 27/40; B32B 2255/02; B32B 2255/10; B32B 2262/02; B32B 2262/0261; B32B 2262/0276; B32B 2307/30; B32B 2307/3065; B32B 2307/54; B32B 2307/714; B32B 2307/724; B32B 2307/7376; B32B 2307/746; B32B 2601/00

(57) ABSTRACT

In some embodiments, the present technology can include a multi-layer cover material having a first material layer, a second material layer disposed over the first material layer, and a third material layer disposed over the second material layer. The second material layer and the third material layer can be coupled to the first material layer and, collectively, the multi-layer cover material can provide certain minimum (i) moisture vapor transport capacity, (ii) chemical resistance, and (iii) flame retardancy, among other characteristics. The multi-layer cover material can be incorporated into a cover layer of a support surface cover, which can be incorporated with a support surface, and used with a hospital bed system.

### CROSS-REFERENCE TO RELATED APPLICATIONS

The present application claims the benefit of U.S. Provisional Patent Application No. 63/493,284 filed Mar. 30, 2023, the disclosure of which is incorporated herein by reference in its entirety.

### TECHNICAL FIELD

This present technology relates to support surface covers, and associated materials, devices, systems, and methods.

### BRIEF DESCRIPTION OF THE DRAWINGS

Features, aspects, and advantages of the presently disclosed technology may be better understood with regard to the following drawings.

FIG. 1 is a front perspective view of a hospital bed system with a support surface cover, configured in accordance with some embodiments of the present technology.

FIG. 2 is an exploded, front perspective view of a support surface cover, configured in accordance with some embodiments of the present technology.

FIG. 3 is a side, cross-sectional view of components at an edge of a support surface cover, configured in accordance with some embodiments of the present technology.

FIG. 4 is a side, cross-sectional view of a portion of a top layer of a support surface cover, configured in accordance with some embodiments of the present technology.

FIG. 5 is a side view diagram of moisture vapor transferability characteristics of a support surface cover, configured in accordance with some embodiments of the present technology.

FIG. 6 is a block flow diagram of a method of manufacturing a support surface cover, configured in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Introduction

Current hospital bed systems can provide an integrated system for supporting an occupant. For example, these systems can incorporate a bed frame, a mattress, and a mattress cover in a single product ecosystem, in which the bed frame supports the mattress, and the mattress cover protects the mattress and provides a surface to support the occupant. Further, the mattress cover can assist operation of certain pneumatic or blower system mattresses, operated by the mattress itself or by the bed frame and/or an external blower device. However, available mattress covers providing the above features fail to adequately perform in clinic and non-clinical settings. For example, these mattress covers fail to provide sufficient moisture vapor transfer, chemical resistance, or flame retardancy, among other characteristics, which can lead to undesirable patient outcomes. Therefore, a need exists to further develop mattress covers and their materials to improve system operation and patient outcomes.

### II. Overview

Embodiments of the present technology relate to support surface covers, and associated materials, devices, systems, and methods. More specifically, embodiments of the present technology relate to support surface covers for use with hospital bed systems and/or support surfaces, and relate to materials and methods for manufacturing these support surface covers. For example, the present technology can relate to support surface covers with a unique combination of materials that improve the cover's functionality in clinical and non-clinical settings. Additionally or alternatively, the present technology can relate to support surface covers able to contract in a manner that maintains an envelope or bladder of circulating air beneath a patient, e.g., for both comfort and removing moisture from between the patient and the mattress. By providing these and other features, the disclosed support surface covers can at least address some of the above-described issues regarding current hospital bed systems, leading to improved patient outcomes.

In some embodiments, the present technology includes a multi-layer cover material having a first material layer, a second material layer disposed over the first material layer, and a third material layer disposed over the second material layer. The second material layer and the third material layer can be coupled to the first material layer. As described herein, the multi-layer cover material can provide a predetermined (i) moisture vapor transport capacity, (ii) chemical resistance, (iii) flame retardancy, (iv) material elasticity or stretch, (v) longevity (e.g., lifespan), and/or (vi) surface coefficient of friction, each of which is described in further detail herein. Having one or more of these features in combination enables the multi-layer cover of the present technology to provide enhanced reliability and usability relative to conventional materials in a wide range of applications, such as serving as a bed sheet in healthcare settings.

The multi-layer cover material can be incorporated into a cover layer of a support surface cover. For example, embodiments of the present technology can include a support surface cover including a first cover layer having an occupant section, a first side section, and the multi-layer cover material. The occupant section can be configured to correspond in shape and size with a top surface of a mattress, and the first side section can be configured to correspond in shape and size to a side surface of the mattress. The first cover layer can further include second, third, and fourth side sections, and can include additional cover layers. For example, the support surface cover can include a second, third, and fourth cover layer, with the second and third cover layers between the first and fourth cover layers. The first and fourth cover layers can define, at least in part, an air bladder, with the third layer having a mesh material and providing a gap therebetween. In some embodiments, the support surface cover can be incorporated as the cover of a support surface; and further, the support surface including the cover can be incorporated into a bed system.

Embodiments of the present technology can improve patient outcomes in connection with prolonged bedrest. For example, the present technology can provide a support surface cover with greater moisture vapor transfer, which enables the support surface cover to remove moisture at the interface between a patient and the cover (e.g., moisture between the patient and the cover) both in greater volumes and/or at a faster rate. By keeping the interface of the patient and the cover as dry, or as minimally wet, the risk for bed sores, infections, skin tears, and/or swellings, among other injuries related to prolonged bedrest, can be reduced.

Further, embodiments of the present technology can help prolong the lifespan and usability of the support surface cover, support surface, and bed system. For example, the multi-layer cover material of the disclosed technology can provide superior chemical resistance, flame retardancy, and stretch, as compared to currently available support surface covers. By providing greater chemical resistance and flame retardancy, the disclosed technology can greater withstand clinical and non-clinical environments where hospital bed systems are used and often require cleaning or disinfecting, along with the risk of exposure to hot equipment. Further, by providing greater stretch, the support surface cover can more easily be installed over the support surface, while maintaining a surface that is both more comfortable for and exerts less pressure on the patient.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### III. Hospital Bed Systems with Support Surfaces

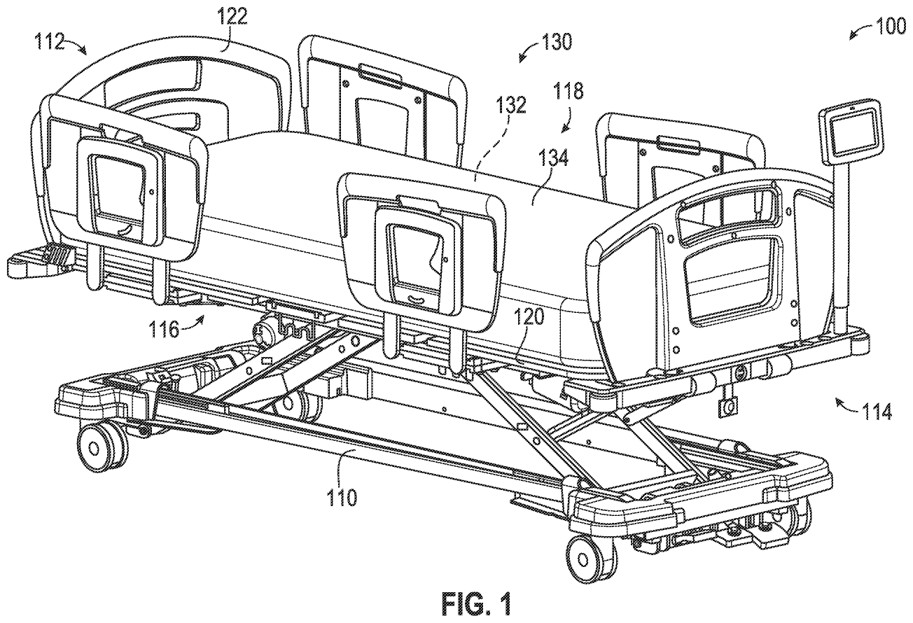

FIG. 1 is a front perspective view of a hospital bed system 100 including a support surface cover 134, configured in accordance with some embodiments of the present technology. As shown, the hospital bed system 100 can be used to support an occupant (e.g., a patient, person, user, etc.) during medical treatment and/or recovery, or during general rest, in a plurality of settings. For example, the hospital bed system can be used in clinical and non-clinical settings, such as hospitals, medical offices, resident care facilities, and during in-home care, among other settings. The system 100 can include a bed frame 110 carrying and/or supporting a support surface 130. The bed frame 110 can have a head section 112 (e.g., a top or upper section or side), a foot section 114 (e.g., a bottom or lower section or side), a right section 116 (e.g., a right side, a first/second lateral side), and a left section 118 (e.g., a left side, a second/first lateral side). The frame 110 can include a platform 120 (e.g., a surface, support, etc.) for carrying and/or supporting the support surface 130, and one or more railings 122 (e.g., boards, handles) at each of the head, foot, right, and/or left sections 112, 114, 116, 118 for positioning the support surface 130 on the platform 120. Further, the frame 110 and/or the system 100 can include the same and/or similar elements as the Auto Leveling Low Profile Support Apparatus of U.S. Patent Application Publication No. 2019/0046377, the disclosure of which is incorporated herein by reference in its entirety.

The support surface 130 can include a mattress 132 (e.g., a support, bed, cushion, padding, etc.). The mattress 132 can be partially or fully encased by the support surface cover 134 (e.g., a wrap, an outer layer or portion), and can include a compressible material and/or a continuous or variable pneumatic system (e.g., blower system) for maintaining the shape of the mattress 130, supporting the occupant, and/or managing a pressure between the occupant and the mattress. Further, the mattress 132 and/or the support surface 130 can include the same and/or similar elements as the Segmented Air Mattress with Variable Stiffness Insert of U.S. Pat. No. 10,835,050, the disclosure of which is also incorporated herein by reference in its entirety.

The cover 134 can protect the mattress 132 from debris, moisture, and/or general wear and tear, in addition to providing other benefits to the support surface 130 and/or the occupant thereon. For example, the cover 134 can separate the occupant from the mattress 132 and facilitate moisture transfer from underneath the occupant and away from the system 100, at least reducing the instances of occupant injury. The cover 134 can transfer moisture across and/or within one or more layers thereof to an unoccupied portion of the mattress 132 where the moisture can evaporate or otherwise leave the system 100. The cover 134 can include one or more layers, each of an air and/or moisture permeable, semipermeable, or impermeable material suitable for clinical and non-clinical medical settings. Some or all of the one or more layers can partially or fully cover a top surface (e.g., an occupant surface) of the mattress 132. Further, some or all of the one or more layers can partially or fully cover one or more side surfaces of the mattress 132.

The cover 134 can be integrally formed with or releasably connected to the mattress 132. For example, in some embodiments, the cover 134 can be integrally formed with the mattress 132 (e.g., via sowing, adhesives, glues, radiofrequency (RF) welding, ultrasonic welding, hot air welding, etc.) at edges of the top and/or a bottom surface of the mattress 132, and/or to one or more surfaces of the mattress 132 for increased support surface 130 structural integrity. In other embodiments, the cover 134 can be releasably connected to the mattress 132 at edges of the top and/or the bottom surface of the mattress 132, and/or to one or more side surfaces of the mattress 132 for case of cleaning, replacement, or manufacturability. For example, the cover 134 can be releasably connected to the mattress 132 using one or more of elastics, zippers, buttons, non-slip surface materials, adhesives, draw strings, and/or any similar, suitable attachment method.

In some embodiment, when the cover 134 has one or more layers including an air-semipermeable or impermeable material, and the mattress 132 includes the pneumatic system, the cover 134 can form a partial or fully air-tight seal with the mattress 132. In these embodiments, the cover 134 can provide or be an air bladder (e.g., pocket, balloon, envelope, etc.) for retaining air within the support surface 130 (e.g., between the mattress 132 and the cover 134) to carry the occupant, and/or to facilitate circulation of conditioned (e.g., heated, cooled, dehumidified, humidified, etc.) or environmental air and/or moisture below the occupant.

### IV. Support Surface Covers

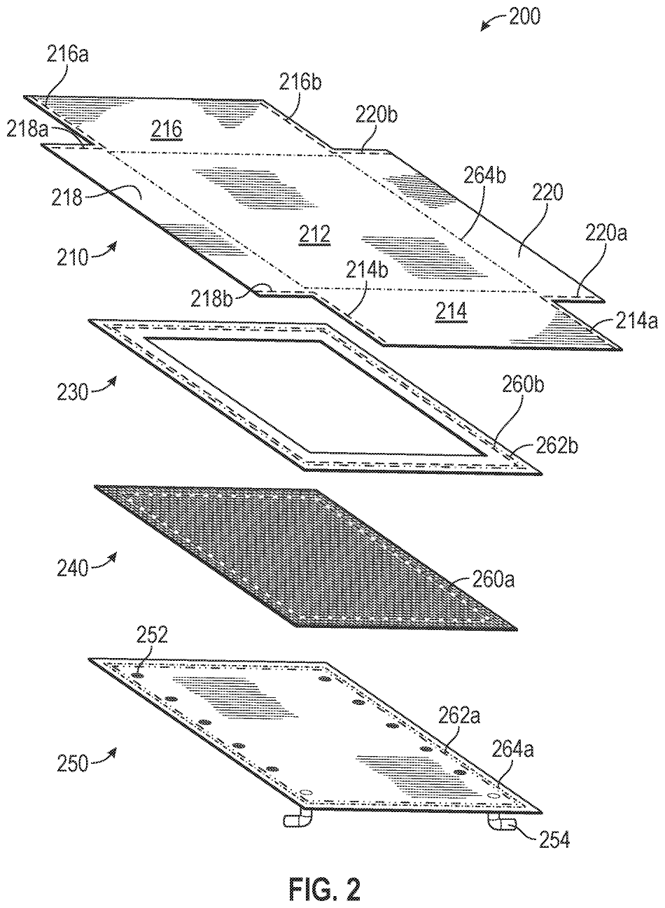

FIG. 2 is an exploded, front perspective view of a support surface cover 200 for use with a hospital bed system and/or a support surface, configured in accordance with some embodiments of the present technology. The cover 200 can be implemented with the support surface 130 of the system 100 described with reference to FIG. 1, e.g., to protect the mattress 132 and to assist operation of a mattress pneumatic system. As shown in FIG. 2, the cover 200 can include sequential air and/or moisture impermeable, semipermeable, and/or permeable layers combine to cover and protect at least an occupant surface and side surfaces of a mattress of the support surface. Further, the cover 200 can define an air bladder for circuiting conditioned and/or environmental air and/or moisture within the cover 200, below an occupant of the mattress, and/or between the mattress and the cover 200.

For example, from the occupant surface down (e.g., from the top of FIG. 2 down), the cover 200 can include: (i) a top layer 210 (e.g., a cover, barrier, contact, or occupant layer, etc.); (ii) a bridge layer 230 (e.g., a frame, middle, or coupling layer, etc.); (iii) a transport layer 240 (e.g., a mesh, permeable, or breathable layer, etc.); and/or (iv) a bottom layer 250 (e.g., a base, lower, or support layer, etc.). The bridge layer 230, the transport layer 240, and the bottom layer 250 can define a lower section of the cover 200, with the bridge layer 230 coupled to the bottom layer 250, and with the transport layer 240 coupled therebetween. The top layer 210 can define an upper section of the cover 200 and can couple to bottom layer 250, with the bridge layer 230 and the transport layer 240 therebetween. The air bladder can be defined by a gap between the top layer 210 and the bottom layer 250, and can include the bridge layer 230 and the transport layer 240, or portions thereof, in the air bladder. The layers 210, 230, 240, 250 can be coupled together via one or more suitable coupling methods, such as sowing, adhesives, glues, RF welding, ultrasonic welding, hot air welding, or any similar, suitable method.

The top layer 210 can directly or indirectly (e.g., when separated by bedding) support the occupant on the mattress. The top layer 210 can include an occupant section 212 (e.g., upper or cover section), a foot section 214 (e.g., a bottom or side section), a head section 216 (e.g., a top or side section), a right section 218 (e.g., a first/second lateral or side section), and a left section 220 (e.g., a second/first lateral or side section). The occupant section 212 can correspond in shape and size to a top surface of the mattress, and an interior surface (e.g., a bottom surface) of the occupant section 212 can be or define a top barrier of the air bladder. The foot and the head sections 214, 216 can each correspond in width to a width of the mattress, and can correspond in length to a height of the mattress. The right and left sections 218, 220 can correspond in width to a length of the mattress, and can correspond in length to the height of the mattress. In some embodiments, the length of one or more of the side sections 214, 216, 218, 220 can be less or greater than the height of the mattress.

The top layer 210 can be an air and moisture semipermeable material suitable for clinical and non-clinical settings, for covering portions of the mattress, and for contacting the occupant. Further, the top layer 210 can be a unitary sheet formed from the material, or one or more of the sections 212, 214, 216, 218, 220 can be independently formed from the material (or different materials) and coupled together. The material can independently provide or prevent, or can be treated to provide or prevent, air and/or moisture permeability, chemical resistance, fire retardance, surface texture (e.g., smoothness, roughness, adhesion, etc.), hygienic properties (e.g., antimicrobial, etc.), elasticity and/or flexibility, tensile strength, odor and/or stain resistance, and/or any similar characteristics. Further, the material can be a single layer of uniform material, or a combination of multiple material layers. For example, the top layer 210 can include a unitary sheet of untreated material including a first layer of air and moisture semipermeable material, such as a polyurethane; a second layer of adhesive bonding the layers of the material together; and a third layer of textile material providing structure and tensile strength.

The top layer 210 can be coupled directly to at least the bottom layer 250, continuously or intermittently, along an attachment path 264. The path 264 is illustrated as path 264a regarding the bottom layer 250, and as path 264b regarding the top layer 210. As shown on the top layer 210, the path 264b can encircle the occupant section 212 at, or inwardly offset from, an exterior edge thereof. Additionally or alternatively, a portion (or all) of the path 264b can be outwardly offset from the exterior edge of the occupant section 212. For example, a portion of the path 264b can be on one or more of the side sections 214, 216, 218, 220. When the top layer 210 and the bottom layer 250 are continuously coupled along the attachment path 264, the coupling can provide a partially or fully air-tight exterior seal of the air bladder.

The side sections 214, 216, 218, 220 of the top layer 210 can each be coupled directly to adjacent side sections 214, 216, 218, 220, continuously or intermittently, along corresponding edge paths to form the corners of the cover 200. That is, when the adjacent side sections 214, 216, 218, 220 are coupled together, the top layer 210 can have a rectangular, box-like shape corresponding with the shape of the mattress. For example, (i) the foot section 214 and the left section 220 can be coupled along a first edge path 214a of the foot section 214 and a first edge path 220a of the left section 220; (ii) the foot section 214 and the right section 218 can be coupled along a second edge path 214b of the foot section 214 and a second edge path 218b of the right section 218; (iii) the head section 216 and the right section 218 can be coupled along a first edge path 216a of the head section 216 and a first edge path 218a of the right section 218; and (iv) the head section 216 and the left section 220 can be coupled along a second edge path 216b of the head section 216 and a second edge path 220b of the left section 220.

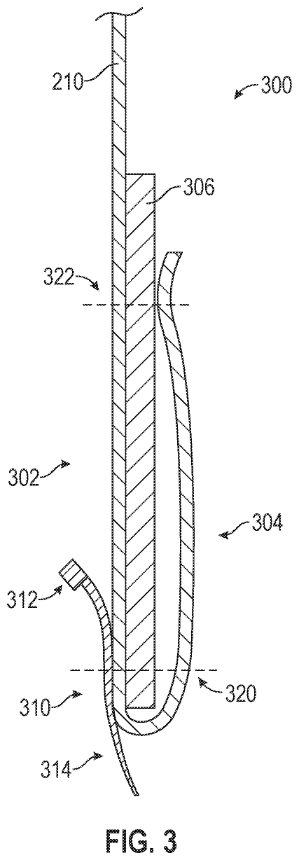

A bottom edge of the coupled side sections 214, 216, 218, 220 can define a bottom edge (e.g., a continuous bottom edge) of the top layer 210 where an attachment assembly (such as the attachment assembly 310 of FIG. 3, infra) can be coupled to, or integrally formed therewith. The attachment assembly can releasably connect the top layer 210 with the mattress. For example, a first zipper portion can be coupled to the top layer 210 and can correspond with a second zipper portion coupled to the mattress.

The bridge layer 230 can carry and/or provide structure to the transport layer 240. That is, the bridge layer 230 can directly couple the transport layer 240 to the bottom layer 250, and can indirectly couple the transport layer 240 to the top layer 210 (e.g., via the bottom layer 250). As shown, the bridge layer 230 can be a frame defining an opening (e.g., an interior edge or section). An exterior edge and the interior edge of the bridge layer 230 can generally correspond in shape with the top surface of the mattress. A width and a length of the exterior edge can be greater than, equal to, or less than the width and the length of the path 264b of the top layer 210, respectively; and can be greater than, less than, or equal to a width and a length of the transport layer 240, respectively. A width and a length of the interior edge of the bridge layer 230 can be equal to or less than the width and the length of the transport layer 240, respectively. Further, as shown, each side of the bridge layer 230 can have a uniform width. In some embodiments, one or more of the sides can have a non-uniform width, and/or one or more of the sides can be omitted.

The bridge layer 230 can be any air and/or moisture permeable, semipermeable, or impermeable material suitable for clinical and non-clinical settings, for providing structure to the transport layer 240, and for coupling the transport layer 240 to the cover 200. Further, the bridge layer 230 can be a unitary sheet of the material, or one or more sides of the bridge layer 230 can be independently formed from the material (or different materials) and coupled together. The material can independently provide or prevent, or can be treated to provide or prevent, air and/or moisture permeability, chemical resistance, fire retardance, surface texture (e.g., smoothness, roughness, adhesion, etc.), hygienic properties (e.g., antimicrobial, etc.), elasticity and/or flexibility, tensile strength, odor and/or stain resistance, and/or any similar characteristics. Further, the material can be a single layer of uniform material, or a combination of multiple material layers. For example, the bridge layer 230 can include a unitary sheet of air and moisture semipermeable or impermeable material, such as a polyurethane, suitable for sowing, adhering, gluing, RF welding, ultrasonic welding, hot air welding, and/or any similar, suitable coupling method between the bridge layer 230 and the transport layer 240, the bottom layer 250, and/or the top layer 210.

The bridge layer 230 can be coupled directly to the transport layer 240, continuously or intermittently, along an attachment path 260. The path 260 is illustrated as path 260a regarding the transport layer 240, and as path 260b regarding the bridge layer 230. The bridge layer 230 can also be coupled directly to the bottom layer 250, continuously or intermittently, along an attachment path 262. The path 262 is illustrated as path 262a regarding the bottom layer 250, and as path 262b regarding the bridge layer 230. As shown on the bridge layer 230, the path 260b corresponding with the transport layer 240 can encircle the opening at, or offset a first distance from, the interior edge of the bridge layer 230. The path 262b corresponding with the bottom layer 250 can encircle the opening at, or offset a second distance from, the interior edge of the bridge layer 230. The first offset distance can be less than, equal to, or greater than the second distance. In some embodiments, the bridge layer 230 can additionally or alternatively be coupled directly to the top layer 210.

The transport layer 240 can be an air and moisture semipermeable or permeable material carried by the bridge layer 230 and can provide a physical separation (e.g., spacing, gap) between the top layer 210 and the bottom layer 250. That is, the transport layer 240 can be directly coupled to the bridge layer 230; and directly or indirectly coupled (i) to the bottom layer 250, and/or (ii) to the top layer 210. For example, the transport layer 240 can be directly coupled to the bridge layer 230; and indirectly coupled (i) to the bottom layer 250 via the bridge layer 230, and (ii) to the top layer 210 via the bridge layer 230 and the bottom layer 250. Further, the transport layer 240 can establish a gap between the top layer 210 and the bottom layer 250, providing the air bladder therebetween, allowing for air and/or moisture to circulate within, and/or be removed from, the cover 200 and below the occupant.

An exterior edge of the transport layer 240 can generally correspond in shape with the top surface of the mattress. More specifically, a width and a length of the exterior edge of the transport layer 240 can be equal to less than the width and the length of the exterior edge of the bridge layer 230, respectively; and can be equal to or greater than the width and the length of the interior edge of the bridge layer 230, respectively. The transport layer 240 can be coupled directly to the bridge layer 230, continuously or intermittently, along the attachment path 260a. As shown, the path 260a can encircle the transport layer 240 at, or offset from, the exterior edge thereof. In some embodiments, the transport layer 240 can additionally or alternatively be coupled directly to the top layer 210 and/or bottom layer 250 along the path 260a and/or another attachment path.

The transport layer 240 can be any air and moisture semipermeable or permeable material suitable for clinical and non-clinical settings, physically separating the top layer 210 and the bottom layer 250, and allowing air and/or moisture to move within (e.g., through and/or along) the material. Further, the transport layer 240 can be a unitary sheet formed from the material, or one or more portions of the transport layer 240 can be independently formed from the material (or different materials) and coupled together. Further, the material can be a single layer of uniform material, or a combination of multiple material layers. For example, the transport layer 240 can include a unitary sheet of natural and/or synthetic, woven, knit, sown, and/or bonded mesh.

The bottom layer 250 can carry the bridge layer 230, and couple the lower section of the cover 200 to the upper section. That is, the bridge layer 230 (with the transport layer 240 carried thereby) can be directly coupled to the bottom layer 250, and the bottom layer 250 can be directly coupled to the top layer 210. Further, an upper surface of the bottom layer 250 can be or define a bottom barrier of the air bladder. An exterior edge of the bottom layer 250 can generally correspond in shape with the top surface of the mattress. More specifically, a width and a length of the exterior edge can be greater than, equal to, or less than the width and length of the occupant section 212 of the top 210.

The bottom layer 250 can include one or more vents 252 for exchanging air and/or moisture into and/or from the air bladder (e.g., into and/or from in-between the bottom surface of the top layer 210 and the top surface of the bottom layer 250). Further, the bottom layer 250 can include one or more pneumatic fittings 254 (e.g., elbow joints, nozzles, inlets, etc.) for interconnecting the airbladder—and the cover 200—with a pneumatic system supply and/or receiver hose of the support surface and/or hospital bed system. When the pneumatic system is engaged with the pneumatic fittings 254, conditioned and/or environmental air can be provided into the air bladder via one or more of the pneumatic fittings 254 and expelled from the air bladder via one or more of the vents 252. Alternatively, conditioned or environmental air can be drawn into the air bladder via one or more of the vents 252 and expelled from the air bladder through one or more of the pneumatic fittings 254. In some embodiments, air can be provided into the air bladder via one or more inlet pneumatic fittings 254 and withdrawn from the air bladder through one or more outlet pneumatic fittings 254. In some embodiments, the top layer 210, the bridge layer 230, and/or the transport layer 240 can additionally or alternatively include vents 252 and/or pneumatic fittings 254. In some embodiments, the vents 252 and/or the pneumatic fittings 254 are used to provide continuous circulation of conditioned or environmental air through the air bladder.

As shown, the bottom layer 250 includes five vents 252 offset from each of, and evenly spaced along, the right and the left sides of the bottom layer 250. Further, the bottom layer 250 includes two pneumatic fittings 254, with one offset from each corner of the bottom layer 250 at the foot section of the mattress. In some embodiments, the bottom layer 250 can include fewer (e.g., 1, 2, 3, 4, 5) or additional (e.g., 8, 10, 20, etc.) vents 252 on the left and/or right sides of the bottom layer 250. Additionally or alternatively, the bottom layer 250 can include one or more vents 252 positioned on the bottom layer 250 to be located over the foot section of, the head section of, and/or centrally located on the top surface of the mattress. Similarly, the bottom layer 250 can include a single or additional (e.g., 4, 8, etc.) pneumatic fittings 254 located on the bottom layer 250 to be positioned over the foot section of, the head section of, and/or centrally located on the top surface of the mattress.

The bottom layer 250 can be coupled directly to the bridge layer 230, continuously or intermittently, along the attachment path 262a; and can be coupled directly to the top layer 210, continuously or intermittently, along the attachment path 264a. As shown on the bottom layer 250, the path 262a corresponding with the bridge layer 230 can encircle the bottom layer 250 offset a first distance from the exterior edge thereof. The path 264a corresponding with the top layer 210 can encircle the bottom layer 250 offset a second distance, less than, equal to, or greater than the first distance, from the exterior edge thereof. One or both of the path 262a corresponding with the bridge layer 230 and the path corresponding with the top layer 264a can be between the exterior edge of the bottom layer 250 and both of the vents 252 and the pneumatic fittings 254. The path corresponding with the bridge layer 230 can instead be inward from the vents 252 and/or the pneumatic fittings 254.

In some embodiments, one or more of the vents 252 and/or the pneumatic fittings 254 are fitted with or otherwise include one or more filter layers. The filter layers can be semipermeable such that air and moisture can pass through (e.g., to prevent over-bellowing), but block pathogens. For example, the filter layers can have a micron rating of no more than 0.1 μm, 0.2 μm, 0.3 μm, 0.4 μm, 0.5 μm, 1 μm, 2 μm, 3 μm, or 0.1-3 μm. In some embodiments, the filter layers block or at least reduce moisture transfer thereacross.

The bottom layer 250 can be any air and/or moisture permeable, semipermeable, or impermeable material suitable for clinical and non-clinical settings, for coupling the bridge layer 230 and the transport layer 240 to the top layer 210, and for contacting the top surface of the mattress. Further, the bottom layer 250 can be a unitary sheet of the material, or one or more portions of the bottom layer 250 can be independently formed from the material (or different materials) and coupled together. The material can independently provide or prevent, or can be treated to provide or prevent, air and/or moisture permeability, chemical resistance, fire retardance, surface texture (e.g., smoothness, roughness, adhesion, etc.), hygienic properties (e.g., antimicrobial, etc.), elasticity and/or flexibility, tensile strength, odor and/or stain resistance, and/or any similar characteristics. Further, the material can be a single layer of uniform material, or a combination of multiple material layers. For example, the bottom layer can include a unitary sheet of air and moisture semipermeable or impermeable material, such as a polyurethane, suitable for sowing, adhering, gluing, RF welding, ultrasonic welding, hot air welding, and/or any similar, suitable coupling method between the bottom layer 250 and the top layer 210, the bridge layer 230, and/or the transport layer 240.

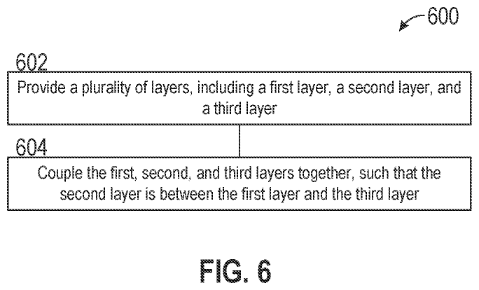

As discussed in greater detail regarding FIG. 6, the top layer 210, the bridge layer 230, the transport layer 240, and the bottom layer 250 (collectedly, “the cover layers”) can be individually manufactured and interconnected to from the cover 200. For example, each of the layers 210, 230, 240, 250 can be cut (e.g., punched, formed, removed, scored, etc.) from raw material (e.g., a roll, a bolt, a pallet, a stack, etc.). Then, the transport layer 240 can be coupled to the bridge layer 230, the bridge layer 230 can be coupled to the bottom layer 250—forming the lower section—, and the bottom layer 250 can be coupled to the top section 210—forming the cover 200. In some embodiments, the bridge layer 230 can instead be coupled directly to the top layer 210, with the transport layer 240 on the top surface or the bottom surface of the bridge layer 230. Further, in some embodiments, the bridge layer 230, the transport layer 240, and/or the bottom layer 250 can be excluded from the cover 200. For example, in some of these embodiments, the cover 200 can exclude the bridge layer 230, the transport layer 240, and the bottom layer 250, and the cover 200 can solely consist of the top layer 210.

In some embodiments, the coupling method for attaching the different layers is based on the material of the layers and features of the coupling method. For example, the transport layer 240 can be composed of a material that is not suitable for welding (e.g., RF welding), and the path 260a defines a path for sowing, adhesives, or other coupling methods. In another example, some layers can be welded together to prevent leakage thereacross, which may occur if the layers are, for example, sewed together.

FIG. 3 is a side, cross-sectional view of the attachment assembly 310 and selected components of the cover 200 of FIG. 2 at the bottom edge 300 thereof, configured in accordance with some embodiments of the present technology. More specifically, FIG. 3 is a side cross-section of the bottom edge 300 (e.g., the hem) of the foot section 214, the head section 216, the right section 218, and/or the left section 220 of the top layer 210 of FIG. 2. As shown in FIG. 3, the bottom edge 300 includes an outer portion 302 of the top layer 210, an inner portion 304 of the top layer 210, a backing 306 between the outer portion 302 and the inner portion 304, and the attachment assembly 310 coupled thereto. The hem of the top layer 210 can form a seal between the cover 200 and the mattress, and can increase the longevity of the cover 200 by reducing instances of fraying or damage at edges of the cover 200.

The outer portion 302, the inner portion 304, the backing 306, and/or the attachment assembly 310 can be coupled together (e.g., interconnected) along a lower attachment path 320; and the outer portion 302, the inner portion 304, and/or the backing 306 can also be coupled together along an upper attachment path 322 to form the edge 300. In some embodiment, the bottom edge 300 can include one or more additional attachment paths above, below, and/or between the lower and the upper attachment paths 320, 322. The outer portion 302, the inner portion 304, the backing 306, and/or the attachment assembly 310 can be coupled along the lower and/or upper attachment paths 320, 322 via one or more suitable coupling methods, such as sowing, adhesives, glues, RF welding, ultrasonic welding, hot air welding, and/or any similar, suitable method.

The backing 306 can be a structural piece extending continuously, partially, and/or intermittently along the bottom edge 300 of the foot section 214, the head section 216, the right section 218, and/or the left section 220 of the top layer 210. The backing 306 can provide structure to the hem of the top layer 210, and can help form and air- and/or moisture-tight seal between the cover 200 and the mattress. For example, the backing 306 can be individual strips of polyurethane and/or plastic continuously extending along the length of each of the bottom edges 300 of the foot section 214, the head section 216, the right section 218, and the left section 220.

The attachment assembly 310 can be any suitable assembly of the cover 200 associated with a corresponding attachment assembly of the mattress (collectively, “the attachment assemblies”) for securely and releasably connecting the cover 200 to the mattress. For example, the attachment assemblies can be corresponding portions of (i) a zipper, (ii) a zipperless slide, (iii) hook and loop, and/or any similar, suitable mechanical attachment means. As shown in FIG. 3, the attachment assembly 310 includes a zipper portion 312 and a seal 314. The zipper portion 312 can correspond with a zipper portion at the bottom edge of the mattress, and the seal 314 can extend past the end of the bottom edge 300, and/or wrap along the bottom of the edge 300, and further form an air- and/or moisture-tight seal between the cover 200 and the mattress when the zipper portions are connected.

### V. Materials for Support Surface Covers

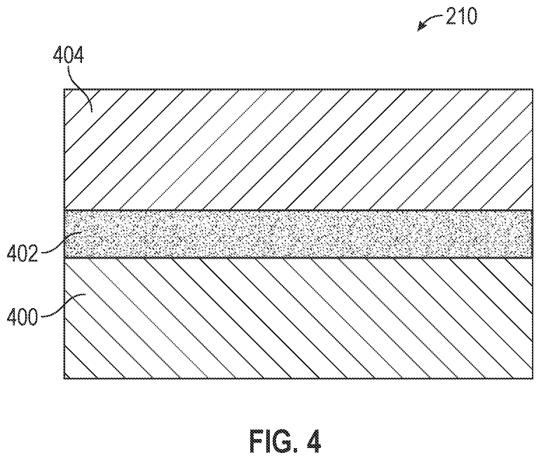

FIG. 4 is a side, cross-sectional view of a selected portion of the top layer 210 from the support surface cover 200 of FIG. 2 at the occupant section 212 (FIG. 2), configured in accordance with some embodiments of the present technology. More specifically, FIG. 4 illustrates a layered configuration of a material forming the top layer 210 (e.g., forming the occupant section 212, the foot section 214, the head section 216, right section 218, and/or the left section 220 of FIG. 2) that provides at least superior chemical resistance, flame retardancy, stretch, and/or moisture vapor transferability, as compared to traditional materials for support surface covers, and/or mattress covers, generally. Further, the material can provide improved material longevity (e.g., lifespan) in high temperature and humidity environments, material manufacturability, and occupant surface coefficient of friction, among other improvements.

The layered configuration of the top layer 210 can include a lower layer 400 (e.g., a bottom, first, base layer, etc.), a middle layer 402 (e.g., a second, coupling, or intermediary layer, etc.), and an upper layer 404 (e.g., a top, third, exterior layer, etc.). Each of the layers 400, 402, 404 can independently provide or prevent, or can be treated to provide or prevent, air and/or moisture permeability, chemical resistance, fire retardance, surface texture (e.g., smoothness, roughness, adhesion, etc.), hygienic properties (e.g., antimicrobial, etc.), elasticity and/or flexibility, tensile strength (e.g., material structure), and/or odor or stain resistance, among other characteristics. Additionally or alternatively, the resultant material can exhibit these characteristics by combining the layers 400, 402, 404 together.

The lower layer 400 can be or have a fabric and/or textile composition providing a predetermined structure, tensile strength, and tear resistance to the material. For example, the lower layer 400 can include natural and/or synthetic (e.g., a thermoplastic, polyester, and/or nylon, etc.) fibers that are woven, knit, sown, and/or bonded together to form a fiber matrix stretchable in-plane with the lower layer 400. Further, the composition of the lower layer 400 can include fibers with a melting point sufficiently low such that the lower layer 400 can partially melt, reform, and fuse with other layers of the top layer 210 (e.g., the middle layer 402, the upper layer 404) and/or other layers of the cover 200 (e.g., the bridge layer 230, the transport layer 240, and/or the bottom layer 250) during a welding assembly operation (e.g., RF welding, ultrasonic welding, hot air welding, etc.). For example, the composition of the lower layer 400 can include nylon 6 and/or nylon 66 with a melting point between 450° F. and 550° F. (e.g., 230° C. and 290° C.), inclusive.

The middle layer 402 can be an adhesive and/or glue suitable for coupling the lower layer 400 and the upper layer 404 together. For example, the middle layer can be formed on and/or adhered to either or both of the lower layer 400 and the upper layer 404, and can be cured to couple the layers 400, 402, 404 together. In another example, when the adhesive is applied to the lower layer 400 and/or the upper layer 404, and the layers 400, 402, 404 are stacked, the layers 400, 402, 404 can be coupled together by the middle layer 402 during a cast coating process. In some embodiments, the adhesive and/or glue material include thermoplastic adhesives (e.g., polycarbonate-based adhesives). The adhesive material can be selected to provide a certain minimum level of chemical resistance. In some embodiments, the adhesive material is selected to avoid certain compounds or solvents known to be harmful to the environment.

The upper layer 404 can have a polymer (e.g., thermoplastic) composition providing chemical resistance, air and/or moisture permeability, surface texture, hygienic properties, elasticity and/or flexibility, and/or odor and stain resistance to the material. For example, the upper layer 404 can have a polyurethane composition with uniform (or non-uniform) thickness between 1-500 μm, 10-250 μm, 50-125 μm, or 80-100 μm, inclusive of any specific value outside these ranges. Further, in some embodiments the upper layer 404 can have a thickness of about 50 μm, 60 μm, 70 μm, 80 μm, 90 μm, 100 μm, 110 μm, 120 μm, or 130 μm, or any specific value therebetween. This composition of the upper layer 404 can perform well across multiple accelerated aging and characteristic tests—and in real-world settings—and can therefore at least provide the above-noted characteristics. Further, the composition of the upper layer 404 can include a polymer with a melting point sufficiently low such that the upper layer 404 can partially melt, reform, and fuse with other layers of the cover 200 during a welding assembly operation. For example, the composition of the upper layer 404 can have a melting point between 450° F. and 550° F. (e.g., 230° C. and 290° C.), inclusive.

The layers 400, 402, 404 can be individually formed, sequentially laid on top of one another, and coupled together. For example, the adhesive and/or glue composition of the middle layer 402 can be activated (e.g., through heat, pressure, chemical reaction, etc.) to bind with the fibers of the lower layer 400 and the polyurethane composition of the upper layer 404. In some embodiments, the layers 400, 402, 404 can undergo a cast coating process, causing the middle layer 402 to partially encroach into the fiber matrices of the lower layer 400 and the polyurethane of the upper layer 404, thereby forming a fused connection between the layers 400, 402, 404 and providing a material with at least the above noted characteristics.

In some embodiments, the upper layer 404 has a mass per unit area (e.g., as determined under ISO 3801/5 1977) of at least 120 g/m², 130 g/m², 140 g/m², 150 g/m², 160 g/m², 170 g/m², 180 g/m², or 120-180 g/m², or any range therebetween (e.g., between 136-167 g/m²). The lower layer 400 can have a mass per unit area (e.g., as determined under ISO 3801/5 1977) of at least 65 g/m², 70 g/m², 75 g/m², 80 g/m², 85 g/m², 90 g/m², 95 g/m², or 65-95 g/m², or any range therebetween. The top layer 210 comprising the lower layer 400, the middle layer 402, and the upper layer 404 can have a mass per unit area (e.g., as determined under ISO 3801/5 1977), of at least 185 g/m², 200 g/m², 215 g/m², 230 g/m², 245 g/m², 260 g/m², 275 g/m², or 185-275 g/m², or any range therebetween.

As compared to traditional materials for support surface covers, the material of the top layer 210 from the cover 200 of FIG. 2, as illustrated in FIG. 4, can at least provide superior chemical resistance, flame retardancy, and stretch, while maintaining levels of moisture vapor transfer through and/or within the material. The material can further provide improvements to material longevity in high temperature and humidity environments, material manufacturability, and occupant surface coefficient of friction, among other characteristics. These characteristics can provide a safe, comfortable surface for an occupant of the mattress; can reduce the instances of occupant injuries associated with prolonged bedrest, such as bed sores, infections, skin tears, and/or swellings, among other potential injuries; and can prolong the lifespan of the cover 200.

The following paragraphs detail top layer 210 material test results illustrating the superior performance of the material as compared to traditional support surface cover materials.

a. Material Chemical Resistance

When used in healthcare settings, the top layer 210 can be frequently exposed to disinfectants, cleaning agents, bodily fluids, medications, and/or other chemicals. Providing the top layer 210 with sufficient chemical resistance to withstand these substances over periods of time without degradation can help maintain hygiene standards and ensure patient comfort. Moreover, a high level of chemical resistance can also serve as a barrier against potential contamination, safeguarding both patients and healthcare workers. Therefore, it can be important for the top layer 210 to exhibit high chemical resistance. Moreover, the top layer 210 with a high level of chemical resistance in combination with one or more of the other features described herein is expected to improve overall patient outcomes.

One method for identifying the chemical resistance of a material is known as the continuous pooling test. During this test, a sample of the material can be suspended taught and horizontal to a floor. In this position, and under standard environmental conditions, one or more common household and/or clinical chemicals can be poured onto the material sample surface. For example, substances generally used for cleaning and/or disinfecting household and/or clinical surfaces, such as chlorine bleach, rubbing alcohol, hydrogen peroxide, and/or similar substances can be poured onto the surface. The chemicals can pool in the center of the material sample, with the pool resting on the material sample for the duration of the test. In some embodiments, the duration can be a few hours (e.g., 2-5 hours), a few days (e.g., 2-5 days), or a few weeks (e.g., 2-5 weeks). During the test, the material sample is analyzed for leaks, surface degradation, and increased sagging in response to the pooled chemicals. Further, additional chemical substances can be added as the original amount evaporates.

During a continuous pooling test, the material comprising the layers 400, 402, 404 can have superior performance as compared to traditional materials of support surface covers. For example, during a chlorine bleach continuous pooling test, the material comprising the layers 400, 402, 404 can last 5-50 times longer than traditional materials before leaking. More specifically, in at least one chlorine bleach test, the material comprising the layers 400, 402, 404 survived a two-week continuous pooling test without signs of wear. In contrast, a traditional material under the same conditions failed after twelve days. Therefore, the material comprising the layers 400, 402, 404 can provide the top layer 210 from the cover 200 of FIG. 2 with superior chemical resistance as compared to traditional support surface covers, increasing the life span of the cover 200, as compared to the traditional support surface covers.

Another method for identifying the chemical resistance of a material is provided by the International Organization for Standardization. Under ISO/TS 20342-10:2022, the material comprising the layers 400, 402, 404 can last or survive, without signs of wear, at least 7 days, 10 days, 14 days, 21 days, or 28 days when subjected to a solution containing about 5,000 ppm of active chlorine. Therefore, the material comprising the layers 400, 402, 404 can provide the top layer 210 from the cover 200 of FIG. 2 with superior chemical resistance as compared to traditional support surface covers, increasing the life span of the cover 200, as compared to the traditional support surface covers.

b. Material Flame Retardancy

It can be particularly important for the top layer 210 to have sufficient flame retardancy. For example, in healthcare settings, certain patients may be physically unable to suppress fires (e.g., unable to properly use a fire extinguisher), may be unable to escape, and/or may have medical conditions that leave them particularly vulnerable to fire. Providing the top layer 210 with sufficient flame retardancy to minimize or at least reduce the risk of ignition and/or the spread of flames can help maintain a safe healthcare environment. Moreover, a high level of flame retardancy can benefit not only patients, but also healthcare workers, staff, family members, etc. Therefore, it can be important for the top layer 210 to exhibit high flame retardancy. Moreover, the top layer 210 with a high level of flame retardancy in combination with one or more of the other features described herein is expected to improve overall patient outcomes.

Multiple methods for identifying flame retardancy of a material exist, two of which include testing (i) for compliance with the California Department of Consumer Affairs' (CA DCA) Technical Bulletin 117-2013 for smoldering resistance of materials used in upholstered furniture, and (ii) for compliance with the Federal Consumer Product Safety Commission's (CPSC) Laboratory Test Manual standards for the flammability of mattresses and mattress pads under 16 C.F.R. Part 1632.

Under Technical Bulletin 177-2013, “cover fabrics” are tested for their tendency to smolder and contribute to fire propagation when subjected to a smoldering ignition source (e.g., a cigarette), in accordance with ASTM E1353-08a. (Tech. Bull. 177-2013, § 1.1). Cover fabrics are compliant if (i) during an initial test, not more than one of three test specimens of the material (a) continues to smolder after the 45 minute test duration, (b) presents a vertical char length of more than 1.8 inches (e.g., 45 mm), or (c) transitions to open flaming; or (ii) during a repeated test, none of three test specimens experiences the conditions identified in items (i) (a)-(c). (Id.). When tested, the material comprising the layers 400, 402, 404 was compliant with CA DCA Tech. Bull. 177-2013 during an initial test, and therefore no repeated tests were necessary. More specifically, during the compliance test, the material had the following results:

TABLE 1
Flame Retardancy of the Disclosed Material,
as Tested Following ASTM E1353-08a

| | CHAR LENGTH | AFTER FLAME | SMOLDERING |
|---|---|---|---|
| | (inch) | (sec.) | (sec.) |
| BARE | 0.4 | 0.0 | 0.0 |
| | 0.4 | 0.0 | 0.0 |
| | 0.4 | 0.0 | 0.0 |
| COVERED | 0.4 | 0.0 | 0.0 |
| | 0.5 | 0.0 | 0.0 |
| | 0.4 | 0.0 | 0.0 |

The CPSC Laboratory Test Manual regarding 16 C.F.R. Part 1632 provides testing procedures regarding the flammability of “mattresses” and “mattress pads” to reduce “the unreasonable risk of property damage, burn injuries, and deaths from fires . . . when [these items are] exposed to a smoldering ignition source (lighted cigarette).” (Lab. Man. § 1.2). Further, regarding 16 C.F.R. Part 1632.6, the Laboratory Manual provides testing procedures regarding the flammability of “mattress ticking substitutions” (e.g., mattress and/or mattress pad material substitutions) that allow for material substitution without retesting of an entire mattress and/or mattress pad prototype. (Id. at Appendix A). Mattress ticking substitutions can be marked as Class A, Class B, or Class C, of which materials marked as Class A do not require additional whole-prototype testing.

To be marked as Class A, three specimens of the substitution material must not char “more than 1 inch (e.g., 2.54 cm) in any direction from the nearest point of the cigarette, and [a] cotton felt [used during testing must] not ignit [e,]” with three cigarettes placed on each specimen. (16 C.F.R § 1632.6 (d)(2) (2022)). When tested, the material comprising the layers 400, 402, 404 was marked as Class A. More specifically, during the compliance test, the material had the following results:

TABLE 2
Flame Retardancy of the Disclosed Material, as
Tested Following 16 C.F.R. § 1632.6

CIGARETTE LOCATION

| | #1 | #2 | #3 |
|---|---|---|---|
| ¼″ Urethane Foam | PASS | PASS | PASS |
| (material having layers | PASS | PASS | PASS |
| 400, 402, 404) on | PASS | PASS | PASS |
| Cotton Felt | | | |
| Cotton Felt | PASS | PASS | PASS |
| | PASS | PASS | PASS |
| | PASS | PASS | PASS |

Further, the material comprising the layers 400, 402, 404 passed the British Standards Institution BS 7175 Crib 5 standard for testing the ignitability of bedcovers and pillows by smoldering and flaming ignition sources; the European Standards BS EN 597 standard, parts 1 and 2, for the assessment of the ignitability of mattresses and upholstered bed bases by a smoldering cigarette; is a baby-safe product under the Oekotex 100 standard; complies with California Proposition 65; complies with REACH, as issued by the European Chemicals Agency; complies with the Restriction of Hazardous Substances (RoHS), as issued by the European Union; and is halogen free. Therefore, the material comprising the layers 400, 402, 404 can provide the top layer 210 from the cover 200 of FIG. 2 with superior material characteristics, while also providing flame retardancy.

c. Material Stretch

When used in healthcare settings, the top layer 210 can be subjected to frequent shifting, prolonged periods of use (e.g., to support bedridden patients) and/or unconventional objects (e.g., casts, medical equipment, etc.). Providing the top layer 210 with sufficient material stretch can improve the durability of the top layer 210 and also ensure patient comfort (and reduce the risk of pressure ulcers). Moreover, a high level of material stretch can help with frequent repositioning and/or bed-making by healthcare workers and/or family members. Therefore, it can be important for the top layer 210 to exhibit sufficient material stretch. Moreover, the top layer 210 with sufficient material stretch in combination with one or more of the other features described herein is expected to improve overall patient outcomes.

One method for identifying the stretch of a material is through a bi-axis stretching test. During this test, a sample of the material can be connected to an apparatus suited to pull the sample along an x- and y-axis. An initial displacement (e.g., a control or starting size) of the sample can be recorded as the unstretched length and width of the material. Pulling forces can be applied to the material sample along the x- and y-axis at incremented, progressively higher forces, with the x- and y-displacement of the material recorded at each increment. Progressively higher pulling forces can be applied until the material is stretched beyond its elastic range. When tested, the material comprising the layers 400, 402, 404 provided a high elastic stretch range. More specifically, during the bi-axis stretching test, the material had the following results:

TABLE 3
Stretch of the Disclosed Material, as
Tested with a Bi-Axis Stretching Test

STRETCH (% over control)
at PULLING FORCE

| | | 18N | 36N |
|---|---|---|---|
| 1st | 1st Axis | 21% | 22% |
| Sample | 2nd Axis | 19% | 27% |
| 2nd | 1st Axis | 38% | 45% |
| Sample | 2nd Axis | 36% | 49% |

Therefore, the material comprising the layers 400, 402, 404 can provide the top layer 210 from the cover 200 of FIG. 2 with superior stretch, improve ease of assembly for coupling the support surface cover to the mattress, and comfort provided to the occupant on the mattress.

The strength and extension of a material can be tested by continuing the tensile or stretching test until the material breaks or ruptures. The tensile force can be applied along two different yarn directions: along warp yarns, which run lengthwise in a woven fabric, and along weft yarns, which run generally perpendicular to the wrap yarns. Under ISO 13934 2013, the material comprising the layers 400, 402, 404 can have a breaking strength warp of at least 300 N/5 cm, 400 N/5 cm, 500 N/5 cm, 600 N/5 cm, 700 N/5 cm, or 300-700 N/5 cm, or any range therebetween. Under ISO 13934 2013, the material comprising the layers 400, 402, 404 can have a breaking strength weft of at least 150 N/5 cm, 250 N/5 cm, 350 N/5 cm, 450 N/5 cm, 550 N/5 cm, or 150-550 N/5 cm, or any range therebetween. Under ISO 13934 2013, the material comprising the layers 400, 402, 404 can have a breaking extension warp of at least 110%, 120%, 130%, 140%, 150%, or 110-150%, or any range therebetween. Under ISO 13934 2013, the material comprising the layers 400, 402, 404 can have a breaking extension weft of at least 120%, 130%, 140%, 150%, 160%, or 120-160%, or any range therebetween.

Under ISO 4674-A1 2016, the material comprising the layers 400, 402, 404 can have a tear strength warp of at least 40 N, 50 N, 60 N, 70 N, 80 N, or 40-80 N, or any range therebetween. Under ISO 4674-A1 2016, the material comprising the layers 400, 402, 404 can have a tear strength weft of at least 25 N, 35 N, 45 N, 55 N, 65 N, or 25-65 N, or any range therebetween.

Under DIN 53357 1982, the material comprising the layers 400, 402, 404 can have an adhesion warp of at least 14 N/22 mm, 16 N/22 mm, 18 N/22 mm, 20 N/22 mm, 22 N/22 mm, or 14-22 N/22 mm, or any range therebetween. Under DIN 53357 1982, the material comprising the layers 400, 402, 404 can have an adhesion weft of at least 14 N/22 mm, 16 N/22 mm, 18 N/22 mm, 20 N/22 mm, 22 N/22 mm, or 14-22 N/22 mm, or any range therebetween.

Under ISO 5077 2007, the material comprising the layers 400, 402, 404 can have warp shrinkage after washing at 95° C. of at least −5%, −3%, 0%, 3%, 5%, or (−5)-5%, or any range therebetween. Under ISO 5077 2007, the material comprising the layers 400, 402, 404 can have weft shrinkage after washing at 95° C. of at least −5%, −3%, 0%, 3%, 5%, or (−5)-5%, or any range therebetween.

d. Material Moisture Vapor Transferability

Moisture vapor transferability relates to the ability of a material to move moisture along, within, and/or through the material. More specifically, moisture vapor transferability comprises three forms of moisture movements, including (i) horizontal moisture transpiration, referencing the movement of liquid-phase moisture along the surface of the material; (ii) moisture vapor transfer, referencing the movement of vapor-phase moisture through the material; and (iii) moisture absorption, referencing the absorption of liquid-phase moisture into the material, and the movement of this moisture along the material and away from the location of absorption, where the moisture can enter the vapor-phase and evaporate from the material.

When used in healthcare settings, for example, the top layer 210 can be in contact with patients for extended periods of time, leading to prolonged exposure to perspiration and other forms of moisture accumulation. Providing the top layer 210 with sufficient moisture vapor transferability can help prevent bedsores, skin irritations, and/or other forms of discomfort and harm to patients, and also maintain hygiene standards and ensure patient comfort. Moreover, an appropriate level of moisture vapor transferability can also help regulate body temperatures of patients. Therefore, it can be important for the top layer 210 to exhibit an appropriate level of moisture vapor transferability. Moreover, the top layer 210 with an appropriate level of moisture vapor transferability in combination with one or more of the other features described herein is expected to improve overall patient outcomes.

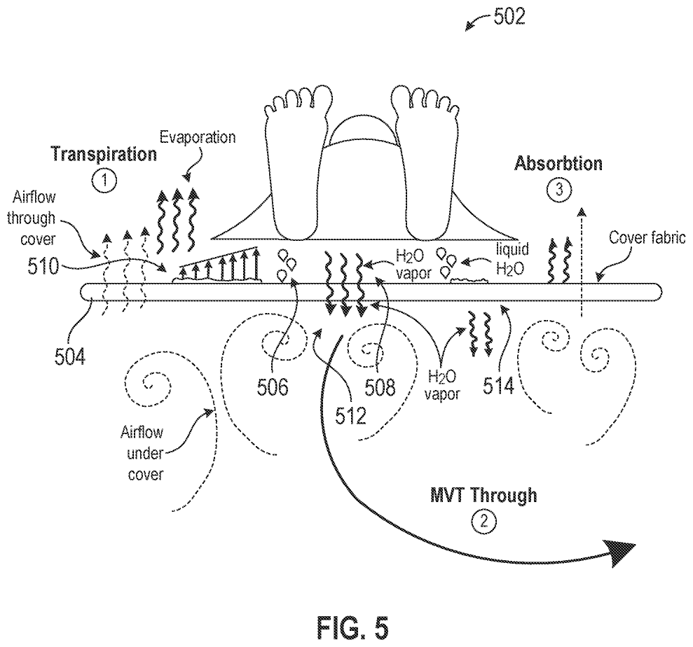

FIG. 5 is a side view diagram at the feet an occupant 502 on a support surface cover 504 of illustrating the characteristics of moisture vapor transferability acting on moisture from the occupant 502 (e.g., sweat, perspiration, etc.), in accordance with some embodiments of the present technology. As shown, the occupant 502 is lying on the support surface cover 504 (such as the support surface cover 200 of FIG. 2) that uses a pneumatic system (e.g., a blower system), and the occupant 502 is producing both liquid-phase moisture 506 and vapor-phase moisture 508. Horizontal moisture transpiration 510 is illustrated along the right side of the occupant 502 (left side as shown in FIG. 5), moisture vapor transfer 512 is illustrated centrally under the occupant 502, and moisture absorption 514 is illustrated along the left side of the occupant 502 (right side as shown in FIG. 5).

As illustrated, through horizontal moisture transpiration 510, liquid-phase moisture from the occupant 502 can move along the surface of the cover 504 both laterally (e.g., where the cover 504 is flat) and vertically (e.g., where the cover 504 is inclined, for example, under the weight of the occupant 502). As the moisture moves along the surface of the cover 504 and away from the occupant 502, portions (or all) of the moisture can evaporate, leaving the surface dry and removing moisture from below the occupant 502. Through moisture vapor transfer 512, the vapor-phase moisture from the occupant 502 can pass through the cover 502, into an air bladder of the cover 504 and/or the mattress, and can be removed from the system by the pneumatic system. Through moisture absorption 514, the liquid-phase moisture can be absorbed into the structure of the cover 504, can move either through and/or along the cover, and can be change to vapor-phase moisture and exit the cover 504—and the system, generally—at a bottom (e.g., interior) surface and/or the top surface thereof.

Multiple methods for identifying the moisture vapor transferability of a material exist, three of which include (i) testing for the solution resistance of a material to a water and isopropyl alcohol solution following the procedure of the American Association of Textile Chemists and Colorists' (AATCC) 193 testing method (e.g., testing for compliance with ISO 23232); (ii) testing for the buffering capacity and transport of liquid sweat of textiles with a sweating guarded-hotplate following the procedure of the Slovenian Institute for Standardization's (SIST) CEN TR 16422 § 4.5.3 standard, Method B of Annex 2; and (iii) testing for the surface wetting and/or surface energy of the material by identifying its dyne value.

Under AATCC 193, a material sample can be tested for whether one of eight water and isopropyl alcohol solutions are absorbed by the material. More specifically, in series, (i) several drops of a 98/2 v/v water/isopropyl alcohol solution (solution no. 1) can be applied to the material sample; (ii) several drops of a 95/5 v/v water/isopropyl alcohol solution (solution no. 2) can be applied to the material sample; (iii) several drops of a 90/10 v/v water/isopropyl alcohol solution (solution no. 3) can be applied to the material sample; (iv) several drops of an 80/20 v/v water/isopropyl alcohol solution (solution no. 4) can be applied to the material sample; (v) several drops of a 70/30 v/v water/isopropyl alcohol solution (solution no. 5) can be applied to the material sample; (vi) several drops of a 60/40 v/v water/isopropyl alcohol solution (solution no. 6) can be applied to the material sample; (vi) several drops of a 50/50 v/v water/isopropyl alcohol solution (solution no. 7) can be applied to the material sample; and (vii) several drops of a 40/60 v/v water/isopropyl alcohol solution (solution no. 8) can be applied to the material sample. The material sample is then said to have a degree of water resistance equal to the solution number at which the water and isopropyl alcohol solution is absorbed by the material sample. In two sequential tested, the material comprising the layers 400, 402, 404 partially failed at solution no. 8. That is, some but not all of the applied solution no. 8 was absorbed by the material. Therefore, the material provided an ISO 23232 solution resistance of 7.5.

Under SIST CEN TR 16422 § 4.5.3, a material sample can be tested for its thermoregulatory properties, including moisture vapor transferability. Specifically under Annex 2, Method B of § 4.5.3, the material sample can be tested in accordance with EN 31092 (e.g., ISO 11092) to identify a buffering index (K_{f}), a sweat transport (F), and a sweat uptake (G₂) thereof. Following Method B, in an environment held at 35° C. and 30% relative humidity, a polyester-woven fabric containing 15 cm³ of evenly distributed water at 35° C. can be placed over a liquid- and vapor-phase impermeable film covering a guarded-hotplate. The material sample can be over the polyester-woven fabric, and both the material sample and the polyester-woven fabric can be carried by a plastic sheet coupled to a scale. Over a 15-minute test duration, the weight of (i) the material sample and the polyester-woven fabric and (ii) the material sample alone can be tracked to identify (i) the amount of water removed from the system, overall, and (ii) the amount of water absorbed by the sample material, alone. When tested, three samples of the material comprising the layers 400, 402, 404 had the following results:

TABLE 4
Moisture Vapor Transferability of the Disclosed
Material, as Tested Following Method B

| | BUFFERING | SWEAT TRANSPORT at | SWEAT |
|---|---|---|---|
| | INDEX | 25°, 50% RH | UPTAKE |
| | (K_{f}) | (F; g/m²h) | (G₂; g) |
| SAMPLE A | 0.32 | 193 | 2.9 |
| SAMPLE B | 0.31 | 172 | 3.0 |
| SAMPLE C | 0.25 | 173 | 2.1 |
| AVERAGE | 0.29 | 179 | 2.7 |

The surface wetting or surface energy of a material sample can be identified (e.g., the dyne value of the material sample can be identified) by applying a series of dyne solutions (e.g., via dyne pen, etc.) on the surface of the sample material, and noting which solution applied to the surface beads (e.g., forms droplets, does not “wet out”). More specifically, dyne solutions ranging from a dyne value of 30 to 72 can be sequentially applied to the surface, in ascending order, until the solution beads thereon. The dyne value of the material is the dyne value of the solution that first beads on the surface thereof. Therefore, the material comprising the layers 400, 402, 404 can provide the top layer 210 from the cover 200 of FIG. 2 with superior moisture vapor transferability, improve comfort provided to the occupant on the mattress and reducing instances of occupant injury.

Under ISO 811 2018, a material can be tested for determining the material's resistance to water penetration under hydrostatic pressure. The material comprising the layers 400, 402, 404 can include waterproofness before washing of at least OK: 1000 G M D mm, OK: 1500 G M D mm, OK: 2000 G M D mm, OK: 2500 G M D mm, OK: 3000 G M D mm, OK: 1000-3000 G M D mm, or any range therebetween. The material comprising the layers 400, 402, 404 can include waterproofness after washing of at least OK: 1000 G M D mm, OK: 1500 G M D mm, OK: 2000 G M D mm, OK: 2500 G M D mm, OK: 3000 G M D mm, OK: 1000-3000 G M D mm, or any range therebetween. The material comprising the layers 400, 402, 404 can also exhibit mold and fungal resistance.

Under the inverted cup test, a material's breathability can be determined under certain conditions. The inverted cup test involves placing the material over a cup and then inverting the cup for testing. In a first version of the test, the cup is filled with water and then inverted, and the change in weight of the cup with water is measured over a period of time. The material comes into direct contact with water in the first version. In a second version of the test, the cup is partially filled with desiccant (e.g., potassium acetate) and an ePTFE film is placed over the material before inverting the cup into a dish with water. The material does not come into direct contact with water in the second version. The desiccant pulls the water vapor through the fabric, and the change in weight of the cup with water is measured over a period of time. The material comprising the layers 400, 402, 404 can have a breathability, as determined by the inverted cup test at 37° C. and 65% relative humidity, of at least 100 g/m²/24 hours, 200 g/m²/24 hours, 300 g/m²/24 hours, 400 g/m²/24 hours, 500 g/m²/24 hours, or 100-500 g/m²/24 hours, or any range therebetween.

e. Material Longevity

One method for identifying the longevity of a material is through accelerated aging testing. Accelerated aging can include exposing the material to environmental conditions exceeding those of normal conductions, such as a “jungle test,” where the material is exposed to high temperatures and humidity for an extended period of time. Under these conditions, the material is estimated to experience aging accelerated by 20-70 times the real-time duration of the test, and the material can be analyzed periodically during the exposure for degradation, if any. For example, the material can be held in an environment with a temperature between 50° C. and 90° C., inclusive, and with a relative humidity between 50% and 100%, inclusive, for between one and six months, or longer. Then, during the test, the material can be periodically (e.g., daily, weekly, monthly, etc.) analyzed to identify any changes in material characteristics, such as, for example, material degradation (e.g., surface breakdown, layer separation, etc.), chemical resistance, flame retardancy, and/or stretch. When exposed to an environment with a temperature of 70° C. and with a relative humidity of 95% for three months (simulating accelerated aging of between about five and fifteen years), the material comprising the layers 400, 402, 404 presented no signs of degradation, whereas traditional support surface covers under similar conditions began to degrade following three to four weeks.

f. Material Manufacturability

The material compositions of the layers 400, 402, 404 can provide for greater case of manufacturability, as compared to traditional support surface covers. As discussed above, the lower layer 400 can include a thermoplastic fiber matrix, the middle layer 402 can include thermoplastic adhesive, and the upper layer 404 can include a thermoplastic polyurethane. By including each of the layers 400, 402, 404 with a thermoplastic material, as opposed to a thermoset material, the resultant material (e.g., the combination of the layers 400, 402, 404) can more easily assemble with corresponding layers of the top layer 210 of the cover 200 of FIG. 2 (e.g., the bridge layer 230, the transport layer 240, and/or the bottom layer 250).

For example, when the top layer 210 is assembled using RF welding, ultrasonic welding, hot air welding, and/or a similar material fusion based assembly method, the thermoplastic materials of the top layer 210 can melt when headed, bond with the corresponding layers, and recure to form a ridged, airtight connection therebetween. In contrast, traditional support surface covers where one or more layers of a material forming the cover include thermoset plastics, these traditional support surface covers resist melting when heated and therefore form a less ridged or airtight connection between layers thereof, leading to a reduced cover lifespan.

g. Material Surface Coefficient of Friction

The surface coefficient of friction of a material can be identified following the procedure of ASTM D1894, which tests for the static and kinetic coefficients of friction for plastic film and sheeting. During the test, a sample material can be attached to the bottom of a sled having a known weight, and the sled can be pulled across a control surface at a speed of 150 mm/minute. The force to initiate movement of the sled, and the force to maintain motion of the sled can be recorded and analyzed to identify the static and kinetic coefficients of friction of the sample material. When tested, the material comprising the layers 400, 402, 404 had the following coefficients of friction:

TABLE 5
Coefficients of Friction of the Disclosed
Material, as Tested Following ASTM D1894

| | COEFFICIENT OF | COEFFICIENT OF |
|---|---|---|
| | FRICTION, STATIC | FRICTION, KINETIC |
| | (Kₛ) | (Kₖ) |
| SAMPLE 1 | 0.350 | 0.370 |
| SAMPLE 2 | 0.310 | 0.340 |
| SAMPLE 3 | 0.180 | 0.220 |
| SAMPLE 4 | 0.340 | 0.380 |
| SAMPLE 5 | 0.300 | 0.320 |
| AVERAGE | 0.296 | 0.326 |

Therefore the material comprising the layers 400, 402, 404 can provide the top layer 210 from the cover 200 of FIG. 2 with a coefficient of friction that can reduce occupant injury by reducing instances of sliding when the mattress is repositioned.

### VI. Methods of Manufacturing Support Surface Covers

FIG. 6 is a block flow diagram of a method 600 of manufacturing a support surface cover, such as the cover 134 of FIG. 1 and/or the cover 200 of FIG. 2, in accordance with embodiments of the present technology. The operations of method 600 are intended for illustrative purposes and are non-limiting. In some embodiments, for example, the method 600 can be accomplished with one or more additional operations not described, without one or more of the operations described, or with operations described and/or not described in an alternative order.

As shown in FIG. 6, the method 600 can include providing a plurality of layers, including a first layer, a second layer, and a third layer (method portion 602); and coupling the first, second, and third layers together, such that the second layer is between the first layer and the third layer (method portion 604). In some embodiment, the method 600 can further include coupling one or more vents (e.g., the vents 252 of FIG. 2) and/or pneumatic fittings (e.g., the pneumatic 254 of FIG. 2) to the support surface cover and/or a layer thereof. In some embodiments, the method 600 can further include providing one or more insignia, labeling, instructions, logos, and/or similar writing on the support surface cover. In some embodiments, the method 600 can further include forming a finalized cover. In some embodiments, the method 600 can further include providing a fourth layer, and coupling the first, second, third, and fourth layers such that the second and third layers are between the first and fourth layers. In some embodiments, the method 600 can include providing a single layer, and can exclude coupling. In some embodiments, the first, second, third, and fourth layers can correspond with one or more of the top layer 210, the bridge layer 230, the transport layer 240, and/or the bottom layer 250 of the cover 200 of FIG. 2.

a. Method Portion 602

As shown in FIG. 6, providing the plurality of layers can include forming the plurality of layers from one or more raw sheet materials. Forming can include cutting, punching, removing, scoring, and/or any similar suitable process performed on the one or more materials to produce the first, second, third, and/or fourth layers. For example, when the first layer corresponds with the top layer 210 of the cover 200 of FIG. 2, forming the first layer can include cutting a material corresponding with the material illustrated in FIG. 4 to form at least the occupant section 212 of the top layer 210. Forming the first layer can further include cutting one or more of the side sections 214, 216, 218, 220 of the top layer 210 from the same material at the same time as the occupant section 212, forming a portion or all of the first layer. In some embodiments, forming the first layer can additionally include cutting one or more of the side sections 214, 216, 218, 220 from the same, or different, material as the occupant section 212, and coupling the one or more of the side sections 214, 216, 218, 220 to the occupant section 212.

When the second layer corresponds with the bridge layer 230 of FIG. 2, forming the second layer can include cutting a polyurethane sheet material (the same as or different from the material of the first layer) to form a shape generally corresponding with the shape of a top surface of a mattress. In some embodiments, the interior of the formed shape can be removed to form the second layer corresponding with a frame, like the bridge layer 230 is illustrated in FIG. 2.

When the second layer or the third layer corresponds with the transport layer 240 of FIG. 2, forming the second layer or the third layer, respectively, can include cutting a mesh sheet material to form a shape generally corresponding with the shape of the top surface of the mattress.

When the third layer or the fourth layer correspond with the bottom layer 250 of FIG. 2, forming the third layer or the fourth layer, respectively, can include cutting a polyurethane sheet material (the same as or different from the material of the first layer and/or the second layer) to form a shape generally corresponding with the shape of the top surface of the mattress.

b. Method Portion 604

Coupling the plurality of layers together can include sequentially and/or simultaneously arranging, and rigidly connecting the layers together. For example, connecting can include sowing, adhesives, glues, RF welding, ultrasonic welding, hot air welding, and/or any similar, suitable coupling method that can rigidly connect the plurality of layers together, and can provide a partially or fully air-tight seal around the edges of an air bladder of the support surface cover. In some embodiments where the support surface cover includes the first, second, and third layers; and where the first layer corresponds with the top layer 210, the second layer corresponds with the transport layer 240, and the third layer corresponds with the bottom layer 250: (i) the second layer can be arranged between the first layer and the third layer (e.g., the first layer can be over the second layer, and the second layer can be over the third layer), and (ii) the first, second, and third layers can be connected along a first attachment path (e.g., the attachment path 264 of FIG. 2) via one or more of the above noted connecting methods. For example, in operation “(ii),” the first, second, and third layers can be RF welded and/or sown together along the first attachment path, with or without an adhesive or glue. Alternatively, in some of these embodiments, the second layer can be connected to the first layer or the third layer first along the first attachment path, and the first and second layers can subsequently be connected along the first attachment path or a second attachment path.

In some embodiments where the support surface cover includes the first, second, third, and fourth layers; and where the first layer corresponds with the top layer 210, the second layer corresponds with the bridge layer 230, the third layer corresponds with the transport layer 240, and the fourth layer corresponds with the bottom layer 250: (i) the second layer can be arranged with (e.g., over) the third layer; (ii) the second and third layers can be connected along a first attachment path (e.g., the attachment path 260 of FIG. 2) via one or more of the above noted connecting methods; (iii) the connected second and third layers can be arranged with (e.g., over) the fourth layer; (iv) the connected second and third layers can be connected with the fourth layer along a second attachment path (e.g., the attachment path 262 of FIG. 2) via one or more of the above noted connecting methods; (v) the first layer can be arranged with (e.g., over) the connected second, third, and fourth layers; and (vi) the first layer can be connected with the connected second, third, and fourth layers along a third attachment path (e.g., the attachment path 264 of FIG. 2) via one or more of the above noted connecting methods. For example, in operation “(ii),” the second and third layers can be sown along the first attachment path. In embodiments where the interior of the second layer is not removed prior to connecting with the second layer, the interior can be removed following operation “(ii).” In operation “(iv),” the connected second and third layers and the fourth layer can be RF welded along the second attachment path. And in operation “(vi),” the first layer and the connected second, third, and fourth layers can be RF welded along the third attachment path.

c. Further Method Portions

In some embodiments, the method 600 can further include coupling one or more vents and/or pneumatic fittings (e.g., cover hardware) to the support surface cover and/or a layer thereof. Additionally or alternatively, the method 600 can further include providing one or more insignia, labeling, instructions, logos, and/or similar writing (e.g., markings) on the support surface cover, and/or a layer thereof. In these embodiments, the cover hardware can be coupled to and/or the markings can be provided on the support surface cover before or after one of the method portions 602 and 604, or between the operations thereof.

For example, the cover hardware (i) can be coupled to the raw sheet material prior to forming the layers of the support surface cover, (ii) can be coupled to one or more of the layers of the support surface cover prior to interconnection thereof, and/or (iii) can be coupled to the support surface cover after interconnection of the layers. The cover hardware can be coupled to the support surface cover by cutting, punching, removing, scoring, and/or any similar suitable process for providing an opening (e.g., hole) to extend the cover hardware therethrough, and mechanically coupling (e.g., riveting, mechanical fastener, sowing, etc.) or chemically fusing (e.g., adhesive, epoxy, glue, welding, etc.) the cover hardware with the support surface cover.

Similarly, the markings (i) can be provided on the raw sheet material prior to forming the layers of the support surface cover, (ii) can be provided on one or more of the layers of the support surface cover prior to interconnection thereof, and/or (iii) can be provided on the support surface cover after interconnection of the layers. The markings can be provided on the support surface cover by screen-printing, heat transfer, etching (e.g., mechanical and/or chemical), and/or any similar suitable marking process.

In some embodiments, the method 600 can further include forming a finalized support surface cover. Finalizing the support surface cover can include forming one or more layers of the support surface cover into sides of the support surface cover—corresponding with sides of the mattress—and establishing corners of the support surface cover. The sides of the support surface cover can be folded (e.g., substantially perpendicular to the occupant surface) and interconnected away from an occupant section of the support surface cover. For example, when the first layer corresponds with the top layer 210 of cover 200 of FIG. 2, and includes the side sections 214, 216, 218, 220, the side sections of the first layer can be folded away from the top surface of the occupant section until edges of adjacent side sections are aligned. The adjacent side sections can be connected along edge attachment paths (e.g., the corresponding first edge paths 214a, 216a, 218a, 220a and second edge paths 214b, 216b, 218b, 220b of FIG. 2) to form the corners of the support surface cover. The adjacent side sections can be connected using one or more of the above noted connecting methods.

In some embodiments, finalizing the support surface cover can further include forming a hem at the bottom edge of the support surface cover, and coupling one or more attachment assemblies to the support surface cover. The hem can be formed continuously or intermittently (e.g., excluding corners) along the bottom edge of the support surface cover formed by the interconnected sides of the support surface cover. For example, a backing (e.g., the backing 306 of FIG. 3) can be placed on an interior, side surface of the support surface cover, distanced from and aligned with the bottom edge of the support surface cover. That is, the backing can be placed on the interior of the support surface cover side corresponding with an outer portion of hem (e.g., the outer portion 302 of FIG. 3). The inner portion of hem between the backing and the bottom edge (e.g., the inner portion 304 of FIG. 3) can be folded over the backing. The inner portion, the backing, and the outer portion can then be connected together along one or more attachment paths (e.g., the upper and/or lower attachment paths 320, 322 of FIG. 3).

A single attachment assembly can be coupled to the support surface cover continuously along the hem thereof, or one or more attachment assemblies can be coupled to the hem on one or more sides of the support surface cover. The attachment assemblies can simultaneously be coupled to support surface cover while connecting the inner portion, the backing, and the outer portion. That is, the attachment assemblies can be coupled to the support surface cover at the time as, and along the same attachment paths as when the hem is formed. In some embodiments, the attachment assemblies can be coupled to the sides of the support surface cover before or after the hem is formed, and along the same or a different attachment path as the hem.

In some embodiments, the method 600 can include providing a single material layer (e.g., a single, first layer), and finalizing the cover with the single layer, and can exclude coupling. In these embodiments, the method 600 can correspond with a method for manufacturing a support surface cover exclusively including a top layer, such as the top layer 210 of the cover 200 of FIG. 2. In these embodiments, the method 600 can include (i) providing a single layer, and (ii) finalizing the single layer into the support surface cover.

Providing the single layer can include forming the single layer from one or more raw sheet materials. For example, when the single layer corresponds with the top layer 210 of the cover 200 of FIG. 2, forming the single layer can include cutting a material corresponding with the material illustrated in FIG. 4 to form at least the occupant section 212 of the top layer 210. Forming the single layer can further include cutting one or more of the side sections 214, 216, 218, 220 of the top layer 210 from the same material and at the same time as the occupant section 212, forming a portion or all of the single layer having a unitary construction. In some embodiments, forming the single layer can additionally include cutting one or more of the side sections 214, 216, 218, 220 from the same, or a different, material as the occupant section 212, and coupling the one or more of the side sections 214, 216, 218, 220 to the occupant section 212.

Finalizing the support surface cover from the single layer can include (i) forming portions of the single layer into sides of the support surface cover and corresponding with sides of the mattress, (ii) forming a hem at a bottom edge of the support surface cover, and (iii) coupling one or more attachment assemblies to the support surface cover. Forming portions of the single layer into sides of the support surface cover can include folding and interconnecting side sections of the single layer. For example, when the single layer corresponds with the top layer 210 of cover 200 of FIG. 2, and includes the side sections 214, 216, 218, 220, the side sections of the single layer can be folded away from an occupant surface of until edges of adjacent side sections are aligned. The adjacent side sections can be connected along edge attachment paths (e.g., the corresponding first edge paths 214a, 216a, 218a, 220a and second edge paths 214b, 216b, 218b, 220b of FIG. 2) to form the corners of the support surface cover. The adjacent side sections can be connected using one or more of the above noted connecting methods.

Forming a hem can include placing a backing (e.g., the backing 306 of FIG. 3) on an interior, side surface of the single layer, distanced from and aligned with the bottom edge of the support surface cover. That is, the backing can be placed on the interior of the single layer corresponding with an outer portion of the hem (e.g., the outer portion 302 of FIG. 3). The inner portion of the hem between the backing and the bottom edge (e.g., the inner portion 304 of FIG. 3) can be folded over the backing. The inner portion, the backing, and the outer portion can be connected together along one or more attachment paths (e.g., the upper and/or lower attachment paths 320, 322 of FIG. 3). Coupling the one or more attachment assemblies to the support surface cover can include, prior to, simultaneously with, or following forming the hem, coupling the attachment assemblies along the same or different attachment paths as the hem.

### VII. Conclusion

It will be apparent to those having skill in the art that changes may be made to the details of the above-described embodiments without departing from the underlying principles of the present technology. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing distances, lengths, time, force, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination, and placed into a respective independent clause. The other clauses can be presented in a similar manner.
1. A multi-layer cover, comprising:
a first material layer;
a second material layer disposed over the first material layer; and
a third material layer disposed over the second material layer, wherein—
   the second material layer and the third material layer are coupled to the first material layer, and
   the multi-layer cover includes:
      a predetermined minimum moisture vapor transport capacity,
      a predetermined minimum chemical resistance, and
      a predetermined minimum flame retardancy.
2. The multi-layer cover of any clause herein, wherein the first material layer is a fabric.
3. The multi-layer cover of any clause herein, wherein the first material layer is a textile.
4. The multi-layer cover of any clause herein, wherein the first material layer includes fibers in a woven, knit, sown, or bonded matrix.
5. The multi-layer cover of any clause herein, wherein the first material layer includes natural fibers.
6. The multi-layer cover of any clause herein, wherein the first material layer includes synthetic fibers having a thermoplastic, polyester, or nylon composition.
7. The multi-layer cover of any clause herein, wherein the first material layer includes synthetic fibers having a melting point between 450° F. and 550° F.
8. The multi-layer cover of any clause herein, wherein the first material layer is stretchable in-plane with the first material layer.
9. The multi-layer cover of any clause herein, wherein the second material layer includes an adhesive composition.
10. The multi-layer cover of any clause herein, wherein the second material layer includes an adhesive.
11. The multi-layer cover of any clause herein, wherein the third material layer includes a polymer composition.
12. The multi-layer cover of any clause herein, wherein the third material layer includes a polyurethane composition.
13. The multi-layer cover of any clause herein, wherein the third material layer includes a thickness between 1-500 μm, 10-250 μm, 50-125 μm, or 80-100 μm.
14. The multi-layer cover of any clause herein, wherein the third material layer has a thickness of at least 50 μm, 60 μm, 70 μm, 80 μm, 90 μm, 100 μm, 110 μm, 120 μm, or 130 μm, or any specific value therebetween.
15. The multi-layer cover of any clause herein, wherein the third material layer has a melting point between 450° F. and 550° F.
16. The multi-layer cover of any clause herein, wherein the first, second, and third material layers are coupled together using cast coating.
17. The multi-layer cover of any clause herein, wherein the first, second, and third material layers are fused together.
18. The multi-layer cover of any clause herein, wherein a moisture vapor transferability of the multi-layer cover, following the American Association of Textile Chemists and Colorists' 193 testing method, includes a solution resistance of at least 7.5.
19. The multi-layer cover of any clause herein, wherein a moisture vapor transferability of the multi-layer cover, following the Slovenian Institute for Standardization's CEN TR 16422 § 4.5.3 standard, Method B of Annex 2, includes:
a buffering index of at least 0.25,
a sweat transport at 25° F. and 50% RH of at least 172 g/m² h, and
a sweat uptake of at least 2.1 g.
20. The multi-layer cover of any clause herein, wherein the multi-layer cover includes a chemical resistance to survive at least fourteen days under a continuous pooling test without signs of wear.
21. The multi-layer cover of any clause herein, wherein the multi-layer cover includes a chemical resistance to survive at least fourteen days under a continuous pooling test using chlorine bleach without signs of wear.
22. The multi-layer cover of any clause herein, wherein the multi-layer cover includes a flame retardancy in compliance with the California Department of Consumer Affairs' Technical Bulletin 117-2013.
23. The multi-layer cover of any clause herein, wherein the multi-layer cover includes a flame retardancy in compliance with the United States Federal Consumer Product Safety Commission's Laboratory Test Manual under 16 C.F.R. Part 1632.
24 The multi-layer cover of any clause herein, wherein the multi-layer cover includes a flame retardancy in compliance with the British Standards Institution BS 7175 Crib 5 standard.
25. The multi-layer cover of any clause herein, wherein the multi-layer cover includes a flame retardancy in compliance with the European Standards BS EN 597 standard, parts 1 and 2.
26. The multi-layer cover of any clause herein, wherein the multi-layer cover includes a flame retardancy in compliance with the Oekotex 100 baby-safe standard.
27. The multi-layer cover of any clause herein, wherein the multi-layer cover includes a flame retardancy in compliance with California Proposition 65.
28. The multi-layer cover of any clause herein, wherein the multi-layer cover includes a flame retardancy in compliance with REACH, as issued by the European Chemicals Agency.
29. The multi-layer cover of any clause herein, wherein the multi-layer cover includes a flame retardancy in compliance with the Restriction of Hazardous Substances, as issued by the European Union.
30. The multi-layer cover of any clause herein, wherein the multi-layer cover includes a material stretch along a first axis between 21% and 38% under a pulling force of 18 N along the first axis.
31. The multi-layer cover of any clause herein, wherein the multi-layer cover includes a material stretch along a second axis between 19% and 36% under a pulling force of 18 N along the second axis.
32 The multi-layer cover of any clause herein, wherein the multi-layer cover includes a material stretch along a first axis between 22% and 45% under a pulling force of 36 N along the first axis.
33 The multi-layer cover of any clause herein, wherein the multi-layer cover includes a material stretch along a second axis between 27% and 49% under a pulling force of 36 N along the second axis.
34. The multi-layer cover of any clause herein, wherein the multi-layer cover includes a material longevity of at least three months without signs of wear in conditions of 70° C. and 95% relative humidity.
35. The multi-layer cover of any clause herein, wherein the third material layer includes a static coefficient of friction between 0.18 and 0.35.
36. The multi-layer cover of any clause herein, wherein the third material layer includes a kinetic coefficient of friction between 0.22 and 0.38.
37. A support surface cover, comprising:
a first cover layer including:
   an occupant section positioned to support an occupant and configured to correspond in shape and size to a top surface of a mattress,
   wherein the first cover layer includes a multi-layer cover comprising:
      a first material layer;
      a second material layer disposed over the first material layer; and
      a third material layer disposed over the second material layer,
      wherein—
         the second material layer and the third material layers are coupled to the first material layer; and
         the multi-layer cover having:
         a predetermined minimum moisture vapor transport capacity,
         a predetermined minimum chemical resistance,
         a predetermined minimum flame retardancy.
38 The support surface cover of any clause herein, wherein the first cover layer further includes:
a first side section configured to correspond in shape and size to a first side surface of the mattress:
a second side section configured to correspond in shape and size to a second side surface of the mattress;
a third side section configured to correspond in shape and size to a third side surface of the mattress; and
a fourth side section configured to correspond in shape and size to a fourth side surface of the mattress.

39. The support surface cover of clause 38, wherein the occupant, first side, second side, third side, and fourth side sections are formed from a unitary sheet of material.

40. The support surface cover of clause 38, wherein:
the first and second sections are connected at a first corner of the support surface cover;
the second and third sections are connected at a second corner of the support surface cover;
the third and fourth sections are connected at a third corner of the support surface cover; and
the fourth and first sections are connected at a fourth corner of the support surface cover.
41. The support surface cover of clause 38, wherein the first, second, third, and fourth side sections are configured to be substantially perpendicular to the occupant section when the support surface cover is positioned over the mattress.
42. The support surface cover of clause 38, wherein a bottom edge of each of the first, second, third, and fourth side sections collectively define a bottom edge of the support surface cover.
43. The support surface cover of any clause herein, further including an attachment assembly coupled to the first cover layer at the bottom edge of the support surface cover.
44. The support surface cover of any clause herein, further including a zipper portion coupled to the first cover layer at the bottom edge of the support surface cover.
45. The support surface cover of any clause herein, further including a zipperless slide portion coupled to the first cover layer at the bottom edge of the support surface cover.
46. The support surface cover of any clause herein, further including a hook and loop portion coupled to the first cover layer at the bottom edge of the support surface cover.
47. The support surface cover of any clause herein, further including a hem in the first cover layer at the bottom edge of the support surface cover.
48 The support surface cover of clause 47, wherein the hem includes a polymer or polyurethane backing.
49. The support surface cover of clause 48, wherein the hem includes an outside portion of the first cover layer on a first side of the backing and an inner portion of the first cover layer on a second side of the backing.
50. The support surface cover of any clause herein, further comprising:
a second cover layer disposed under the first cover layer, and
a third cover layer disposed under the second cover layer.
51. The support surface cover of clause 50, wherein the second and third cover layers each correspond in shape to the top surface of the mattress.
52. The support surface cover of clause 50, wherein a width and a length of each of the second and third cover layer are the same as or less than a width and a length of the occupant section, respectively.
53. The support surface cover of clause 52, wherein the width and the length of the third cover layer are the same as or greater than the width and the length of the second cover layer, respectively.
54. The support surface cover of clause 50, wherein the second cover layer includes an air and moisture permeable material.
55. The support surface cover of clause 50, wherein the second cover layer includes a natural or synthetic mesh material.
56. The support surface cover of clause 50, wherein the third cover layer includes a polyurethane material.
57. The support surface cover of clause 50, wherein the third cover layer includes a vent.
58. The support surface cover of clause 50, wherein the third cover layer includes a pneumatic fitting.
59 The support surface cover of clause 50, wherein the first cover layer and the third cover layer define an air bladder therebetween.
60. The support surface cover of clause 50, wherein the first, second, and third cover layers are coupled together.
61. The support surface cover of clause 60, wherein the first, second, and third cover layers are coupled together by radiofrequency welding.
62 The support surface cover of any clause herein, further comprising:
a second cover layer disposed under the first cover layer,
a third cover layer disposed under the second cover layer, and
a fourth cover layer disposed under the third cover layer.
63. The support surface cover of clause 62, wherein the third and fourth cover layers each correspond in shape to the top surface of the mattress.
64. The support surface cover of clause 62, wherein a width and a length of each of the third and fourth cover layers are the same as or less than a width and a length of the occupant section, respectively.
65. The support surface cover of clause 64, wherein the width and the length of the third cover layer are the same as or less than the width and the length of the fourth cover layer, respectively.
66. The support surface cover of clause 62, wherein an exterior shape of the second cover layer corresponds in shape to the top surface of the mattress, and the second cover layer further defines an interior opening.
67. The support surface cover of clause 62, wherein the second cover layer includes a polyurethane material.
68. The support surface cover of clause 62, wherein the third cover layer includes an air and moisture permeable material.
69. The support surface cover of clause 62, wherein the third cover layer includes a natural or synthetic mesh material.
70. The support surface cover of clause 62, wherein the fourth cover layer includes a polyurethane material.
71 The support surface cover of clause 62, wherein the fourth cover layer includes a vent.
72. The support surface cover of clause 62, wherein the fourth cover layer includes a pneumatic fitting.
73. The support surface cover of clause 62, wherein the first cover layer and the fourth cover layer define an air bladder therebetween.
74. The support surface cover of clause 62, wherein the first, second, third, and fourth cover layers are coupled together.
75. The support surface cover of clause 62, wherein the third cover layer is sown to the second cover layer, the third cover layer is radiofrequency welded to the fourth cover layer, and the fourth cover layer is radiofrequency welded to the first cover layer.
76. The support surface cover of clause 62, wherein the third cover layer is sown to the second cover layer, the third cover layer is radiofrequency welded to the first cover layer, and the fourth cover layer is radiofrequency welded to the first cover layer.
77. A support surface, comprising:
a mattress; and
a support surface cover, the support surface cover comprising:
   a first cover layer including:
      an occupant section configured to correspond in shape and size to a top surface of the mattress; and
      at least one side section extending from the occupant section, and configured to correspond in shape and size to a side surface of the mattress,
      wherein the top cover layer includes a multi-layer cover material having:
         a first material layer;
         a second material layer disposed over the first material layer; and
         a third material layer disposed over the second material layer,
         wherein—
         the second material layer and the third material layers are coupled to the first material layer; and
         the multi-layer cover material having:
         a predetermined minimum moisture vapor transport capacity,
         a predetermined minimum chemical resistance,
         a predetermined minimum flame retardancy.
78. The support surface of any clause herein, wherein the mattress includes a continuous or variable pneumatic inflation system.
79. The support surface of any clause herein, wherein the mattress includes a compressible material.
80. A bed system, comprising:
a bed frame; and
a support surface including a mattress and a support surface cover, the support surface cover including:
   a first cover layer including:
      an occupant section configured to correspond in shape and size to a top surface of the mattress; and
      at least one side section extending from the occupant section, and configured to correspond in shape and size to a side surface of the mattress,
      wherein the top cover layer includes a multi-layer cover material having:
         a first material layer;
         a second material layer disposed over the first material layer; and
         a third material layer disposed over the second material layer,
         wherein—
         the second material layer and the third material layers are coupled to the first material layer; and
         the multi-layer cover material having:
         a predetermined minimum moisture vapor transport capacity,
         a predetermined minimum chemical resistance,
         a predetermined minimum flame retardancy.
81. The bed system of any clause herein, wherein the bed frame includes a blower system operably coupled to a pneumatic inflation system of the mattress.
82. A method for manufacturing a support surface cover, the method comprising:
providing a plurality of cover layers, including:
   a first cover layer;
   a second cover layer; and
   a third cover layer; and
coupling the first, second, and third fourth cover layers together such that the second cover layer is between the first and third cover layers.
83 The method of any clause herein further comprising finalizing the support surface cover, finalizing including:
positioning sides of the first cover layer away from an occupant surface of the support surface cover;
connecting adjacent sides of the first cover layer to form corners and a bottom edge of the support surface cover;
forming a hem with the first cover layer at the bottom edge; and
coupling an attachment assembly to the first cover layer at the bottom edge.
84. The method of any clause herein, wherein providing the plurality of cover layers further includes a fourth cover layer, and coupling further includes coupling such that the second and third cover layers are between the first and fourth cover layers.
85. The method of any clause herein, wherein providing the plurality of cover layers includes cutting, punching, removing, or scoring a raw sheet material to form the first, second, third, and/or fourth cover layers.
86. The method of any clause herein, wherein providing the plurality of cover layers further includes coupling one or more vents to the first, second, third, and/or fourth cover layer.
87 The method of any clause herein, wherein providing the plurality of cover layers further includes coupling one or more pneumatic fittings to the first, second, third, and/or fourth cover layer.
88. The method of any clause herein, wherein providing the plurality of cover layers further includes providing a marking on the first, second, third, and/or fourth cover layer.
89. The method of any clause herein, wherein coupling further includes:
arranging the second cover layer over the third cover layer; and
coupling the second and third cover layers together.
90. The method of clause 89, wherein coupling the second and third cover layers together includes sowing.
91. The method of clause 89, further comprising removing an interior portion of the second layer.
92. The method of any clause herein, wherein coupling further includes:
arranging the second cover layer over the fourth cover layer; and
coupling the second and fourth cover layers together.
93. The method of clause 92, wherein coupling the second and third cover layers together includes radiofrequency welding.
94. The method of any clause herein, wherein coupling further includes:
arranging the first cover layer over the fourth cover layer; and
coupling the first and fourth cover layers together.
95. The method of clause 94, wherein coupling the second and third cover layers together includes radiofrequency welding.
96. The multi-layer cover of any clause herein, wherein the multi-layer cover includes a chemical resistance to remain leak-free for at least fourteen days during which the multi-layer cover is subjected to a solution containing 5,000 ppm of active chlorine without signs of wear.
97. The multi-layer cover of any clause herein, wherein the multi-layer cover includes a breathability of at least 300 g/m²/24 hours under an inverted cup test at 37° C. and 65% relative humidity.
98. The multi-layer cover of any clause herein, wherein the multi-layer cover includes a breaking strength warp of at least 500 N/5 cm under ISO 13934:2013 and a breaking strength weft of at least 350 N/5 cm under ISO 13934:2013.

I/We claim:

1. A multi-layer cover, comprising:
a first material layer;
a second material layer disposed over the first material layer; and
a third material layer disposed over the second material layer,
wherein—
the second material layer and the third material layer are coupled to the first material layer,
a perimeter of the multi-layer cover is non-rectangular, and
the multi-layer cover includes:
a predetermined minimum moisture vapor transport capacity,
a predetermined minimum chemical resistance, and
a predetermined minimum flame retardancy.

2. The multi-layer cover of claim 1, wherein the first material layer is directly fused with the second material layer and the third material layer.

3. The multi-layer cover of claim 1, wherein the first material layer includes a first thermoplastic material and the second material layer includes a second thermoplastic material, and wherein the first thermoplastic material is directly fused with the second thermoplastic material via a welding process.

4. The multi-layer cover of claim 1, wherein the third material layer includes a thickness between 80-100 μm, wherein the third material layer has a melting point between 450° F. and 550° F.

5. The multi-layer cover of claim 1, wherein a moisture vapor transferability of the multi-layer cover, following the American Association of Textile Chemists and Colorists' 193 testing method, includes a solution resistance of at least 7.5.

6. The multi-layer cover of claim 1, wherein a moisture vapor transferability of the multi-layer cover, following the Slovenian Institute for Standardization's CEN TR 16422 § 4.5.3 standard, Method B of Annex 2, includes:
a buffering index of at least 0.25,
a sweat transport at 25° F. and 50% RH of at least 172 g/m² h, and
a sweat uptake of at least 2.1 g.

7. The multi-layer cover of claim 1, wherein the multi-layer cover includes a chemical resistance to remain leak-free for at least fourteen days during which the multi-layer cover is subjected to a solution containing 5,000 ppm of active chlorine without signs of wear.

8. The multi-layer cover of claim 1, wherein the multi-layer cover includes a breathability of at least 300 g/m²/24 hours under an inverted cup test at 37° C. and 65% relative humidity.

9. The multi-layer cover of claim 1, wherein the multi-layer cover includes a breaking strength warp of at least 500 N/5 cm under ISO 13934:2013 and/or a breaking strength weft of at least 350 N/5 cm under ISO 13934:2013.

10. The multi-layer cover of claim 1, wherein the multi-layer cover includes a chemical resistance to survive at least fourteen days under a continuous pooling test using chlorine bleach without signs of wear.

11. The multi-layer cover of claim 1, wherein the multi-layer cover includes a material stretch along a first axis between 21% and 38% under a pulling force of 18 N along the first axis, and/or a material stretch along a second axis between 19% and 36% under a pulling force of 18 N along the second axis.

12. The multi-layer cover of claim 1, wherein the multi-layer cover includes a material stretch along a first axis between 22% and 45% under a pulling force of 36 N along the first axis, and/or a material stretch along a second axis between 27% and 49% under a pulling force of 36 N along the second axis.

13. The multi-layer cover of claim 1, wherein the multi-layer cover includes a material longevity of at least three months without signs of wear in conditions of 70° C. and 95% relative humidity.

14. The multi-layer cover of claim 1, wherein the third material layer includes a static coefficient of friction between 0.18 and 0.35, and/or a kinetic coefficient of friction between 0.22 and 0.38.

15. The multi-layer cover of claim 1, wherein the first material layer includes at least one of synthetic fibers having a thermoplastic, polyester, or nylon composition, or synthetic fibers having a melting point between 450° F. and 550° F.

16. The multi-layer cover of claim 1, wherein the first, second, and third material layers are coupled together using cast coating.

17. The multi-layer cover of claim 1, wherein:
the first material layer includes at least one of (i) synthetic fibers having a thermoplastic, polyester, or nylon composition, or (ii) synthetic fibers having a melting point between 450° F. and 550° F.;
the second material layer includes an adhesive; and
the third material layer includes thermoplastic polyurethane.

18. A support surface cover, comprising:
a first cover layer including:
an occupant section positioned to support an occupant and configured to correspond in shape and size to a top surface of a mattress,
wherein the first cover layer includes a multi-layer cover comprising:
a first material layer having a non-rectangular perimeter;
a second material layer disposed over the first material layer; and
a third material layer disposed over the second material layer,
wherein—
the second material layer and the third material layers are coupled directly to the first material layer; and
the multi-layer cover comprises:
a predetermined minimum moisture vapor transport capacity,
a predetermined minimum chemical resistance,
a predetermined minimum flame retardancy.

19. The support surface cover of claim 18, further including an attachment assembly coupled to the first cover layer at a bottom edge of the support surface cover, wherein the attachment assembly comprises a zipper portion, a zipperless slide portion, or a hook and loop portion.

20. The support surface cover of claim 18, further including a hem in the first cover layer at the bottom edge of the support surface cover, wherein the hem includes a polymer or polyurethane backing, and wherein the hem includes an outside portion of the first cover layer on a first side of the backing and an inner portion of the first cover layer on a second side of the backing.

21. The support surface cover of claim 18, further comprising:
a second cover layer disposed under the first cover layer, and
a third cover layer disposed under the second cover layer, wherein the third cover layer includes a vent and a pneumatic fitting.

22. The support surface cover of claim 21, wherein the first cover layer and the third cover layer define an air bladder therebetween.

23. The support surface cover of claim 18, further comprising:
a second cover layer disposed under the first cover layer,
a third cover layer disposed under the second cover layer, and
a fourth cover layer disposed under the third cover layer.

24. The support surface cover of claim 23, wherein the fourth cover layer includes a vent and a pneumatic fitting.

25. A method for manufacturing a support surface cover, the method comprising:
providing a plurality of cover layers, including:
a first cover layer including a first thermoplastic material;
a second cover layer including a second thermoplastic material; and
a third cover layer including a third thermoplastic material; and
coupling the first, second, and third cover layers together such that the second cover layer is between the first and third cover layers and the first cover layer is directly fused with each of the second and third cover layers.

26. The method of claim 25, further comprising finalizing the support surface cover by:
positioning sides of the first cover layer away from an occupant surface of the support surface cover;
connecting adjacent sides of the first cover layer to form corners and a bottom edge of the support surface cover;
forming a hem with the first cover layer at the bottom edge; and
coupling an attachment assembly to the first cover layer at the bottom edge.

27. The method of claim 25, wherein providing the plurality of cover layers further includes a fourth cover layer, and coupling further includes coupling such that the second and third cover layers are between the first and fourth cover layers.

28. The method of claim 27, wherein providing the plurality of cover layers further includes:
coupling one or more vents to the first, second, third, and/or fourth cover layer;
coupling one or more pneumatic fittings to the first, second, third, and/or fourth cover layer; and
providing a marking on the first, second, third, and/or fourth cover layer.

29. The method of claim 25, wherein coupling further includes:
arranging the second cover layer over the third cover layer;
coupling the second and third cover layers together; and
removing an interior portion of the second layer.

30. A support surface cover for a mattress, the cover comprising:
a top layer including an occupant section and four side sections coupled to a periphery of the occupant section, wherein a perimeter of the top layer is non-rectangular, and
wherein the top layer includes:
a fabric layer having a melting point between 450° F. and 550° F.;
a polymer composition layer; and
an adhesive layer between the fabric layer and the polymer composition layer;
a bridge layer disposed underneath the top layer, wherein the bridge layer includes a frame defining a rectangular opening at an intermediate area of the frame;
a transport layer disposed underneath the bridge layer; and
a bottom layer disposed underneath the transport layer, wherein the bottom layer includes a plurality of vents and one or more pneumatic fittings,
wherein:
the occupant section and the bottom layer are coupled along a first peripheral path,
the bridge layer and the bottom layer are coupled along a second peripheral path,
the bridge layer and the transport layer are coupled along a third peripheral path, and
the top layer and the bottom layer define an air bladder therebetween.
